(19) United States
(12) Patent Application Publication
(10) Pub. No.: US 2026/0172936 A1
(43) Pub. Date: Jun. 18, 2026

(54) Wireless Device, Network Node, and Methods Performed Thereby for Handling a Future Outage of Coverage

(71) Applicant: Telefonaktiebolaget LM Ericsson (publ), Stockholm (SE)

(72) Inventors: Badawi Yamine, Beirut (LB); Henrik Rydén, Stockholm (SE)

(21) Appl. No.: 19/111,872

(22) PCT Filed: Nov. 1, 2022
(86) PCT No.: PCT/SE2022/051000

§ 371 Date: Mar. 14, 2025

(51) Int. Cl. H04W 36/30; H04W 36/00; H04W 36/32

(52) U.S. Cl. CPC H04W 36/305; H04W 36/0061; H04W 36/322

(57) ABSTRACT

A method performed by a wireless device (130), for handling a future outage of coverage. The wireless device (130) operates in a wireless communications network (100). The wireless device (130) determines (203), wherein the future outage of coverage is unplanned and a duration of time of the future outage of coverage is unknown, an estimation of the time of duration of the outage of coverage. The wireless device (130) also determines (205), after experiencing the outage of coverage at a first cell (121), whether or not to initiate a new connection setup to a second cell (122), based on the determined estimation.

### TECHNICAL FIELD

The present disclosure relates generally to a wireless device, and methods performed thereby, for handling a future outage of coverage. The present disclosure also relates generally to a network node and methods performed thereby for handling the future outage of coverage.

### BACKGROUND

Wireless devices within a wireless communications network may be e.g., User Equipments (UEs), stations (STAs), mobile terminals, wireless terminals, terminals, and/or Mobile Stations (MS). Wireless devices may be enabled to communicate wirelessly in a cellular communications network or wireless communication network, sometimes also referred to as a cellular radio system, cellular system, or cellular network. The communication may be performed e.g., between two wireless devices, between a wireless device and a regular telephone and/or between a wireless device and a server via a Radio Access Network (RAN) and possibly one or more core networks, comprised within the wireless communications network. Wireless devices may further be referred to as mobile telephones, cellular telephones, laptops, or tablets with wireless capability, just to mention some further examples. The wireless devices in the present context may be, for example, portable, pocket-storable, hand-held, computer-comprised, or vehicle-mounted mobile devices, enabled to communicate voice and/or data, via the RAN, with another entity, such as another terminal or a server.

The wireless communications network covers a geographical area which may be divided into cell areas, each cell area being served by a network node, which may be an access node such as a radio network node, radio node or a base station, e.g., a Radio Base Station (RBS), which sometimes may be referred to as e.g., gNB, a radio base station in New Radio (NR), evolved Node B (“eNB”), “eNodeB”, “NodeB” or “B node”, a radio base station in Long Term Evolution (LTE), Transmission Point (TP), or Base Transceiver Station (BTS), depending on the technology and terminology used. The base stations may be of different classes such as e.g., Wide Area Base Stations, Medium Range Base Stations, Local Area Base Stations, Home Base Stations, pico base stations, etc . . . , based on transmission power and thereby also cell size. A cell is the geographical area where radio coverage is provided by the base station or radio node at a base station site, or radio node site, respectively. One base station, situated on the base station site, may serve one or several cells. Further, each base station may support one or several communication technologies. The base stations may communicate over the air interface operating on radio frequencies with the terminals within range of the base stations. The wireless communications network may also be a non-cellular system, comprising network nodes which may serve receiving nodes, such as wireless devices, with serving beams. In 3rd Generation Partnership Project (3GPP) Long Term Evolution (LTE), base stations, which may be referred to as eNodeBs or even eNBs, may be directly connected to one or more core networks. In the context of this disclosure, the expression Downlink (DL) may be used for the transmission path from the base station to the wireless device. The expression Uplink (UL) may be used for the transmission path in the opposite direction i.e., from the wireless device to the base station.

The standardization organization 3GPP is currently in the process of specifying a New Radio Interface called NR or 5G-UTRA, as well as a Fifth Generation (5G) Packet Core Network, which may be referred to as Next Generation (NG) Core Network (CN), abbreviated as NG-CN, NGC or 5G CN. NG may be understood to be the interface/reference point between the RAN and the CN in 5G/NR.

### Internet of Things (IoT)

The Internet of Things (IoT) may be understood as an internetworking of communication devices, e.g., physical devices, vehicles, which may also be referred to as “connected devices” and “smart devices”, buildings and other items—embedded with electronics, software, sensors, actuators, and network connectivity that may enable these objects to collect and exchange data. The IoT may allow objects to be sensed and/or controlled remotely across an existing network infrastructure.

“Things,” in the IoT sense, may refer to a wide variety of devices such as heart monitoring implants, biochip transponders on farm animals, electric clams in coastal waters, automobiles with built-in sensors, DNA analysis devices for environmental/food/pathogen monitoring, or field operation devices that may assist firefighters in search and rescue operations, home automation devices such as the control and automation of lighting, heating, e.g. a “smart” thermostat, ventilation, air conditioning, and appliances such as washer, dryers, ovens, refrigerators or freezers that may use telecommunications for remote monitoring. These devices may collect data with the help of various existing technologies and then autonomously flow the data between other devices.

It is expected that in a near future, the population of IoT devices will be very large. Various predictions exist, among which one assumes that there will be >60000 devices per square kilometer, and another assumes that there will be 1000000 devices per square kilometer. A large fraction of these devices are expected to be stationary, e.g., gas and electricity meters, vending machines, etc.

### Machine Type Communication (MTC)

Machine Type Communication (MTC) has in recent years, especially in the context of the Internet of Things (IoT), shown to be a growing segment for cellular technologies. An MTC device may be a communication device, typically a wireless communication device or simply user equipment, that may be understood to be a self and/or automatically controlled unattended machine and that may be understood to be typically not associated with an active human user in order to generate data traffic. An MTC device may be typically simpler, and typically associated with a more specific application or purpose, than, and in contrast to, a conventional mobile phone or smart phone. MTC may be understood to involve communication in a wireless communication network to and/or from MTC devices, which communication typically may be of quite different nature and with other requirements than communication associated with e.g. conventional mobile phones and smart phones. In the context of and growth of the IoT, it is evident that MTC traffic will be increasing and thus needs to be increasingly supported in wireless communication systems.

### Radio Coverage Outage

In any wireless mobile network, a UE (User Equipment) may lose the radio coverage from its serving cell running on a certain Radio Access Technology (RAT), e.g., 5G. Even though this may happen rarely, the UE may encounter such situation at any time, and at any geographical location in the wireless network. In general, a UE may lose its radio coverage from a serving cell, e.g. cell1, in two different groups of situations. A first group may be where the radio coverage loss of cell1 may be due to a planned outage. A planned outage may be understood as an activity planned in advance by an operator or by any autonomous tool implemented at the network, e.g., at Operations Support System (OSS), that may take, at a specific time, e.g., t_outage, one or more cells down. A second group may be where the radio coverage loss of cell1 may be due to a non-planned outage. Some examples of a non-planned outage may be as follows. One example may be when the cell1 may have suddenly gone to disabled state due to an equipment failure, e.g., the Radio Unit that may feed cell1 may be go down due to a hardware failure. Another example may be when the subscriber carrying the UE may have moved away from the radio coverage of cell1 towards an area where there may be no radio coverage, e.g., the subscriber may have underground where there is no antenna relay to extend the outside 5G radio coverage to the underground. A further example may be when the subscriber may have moved to an outdoor area where there may be a hole of 5G radio coverage, e.g., due to an insufficient radio coverage optimization that may have been performed by the operator.

For example, at time t1, a UE being served by cell1 running on one RAT, e.g. 5G, loses its radio coverage from cell1. As a consequence, after t1, the UE may be left in one of the following three situations: 1) the UE has no radio coverage at all, 2) the UE receives radio coverage from another cell, running on another RAT, e.g. 4G, and 3) the UE receives radio coverage from another cell running on the same RAT, 5G. When the second situation occurs, that is when the UE finds a suitable cell on a cell, e.g., cell2, running on another RAT, e.g. 4G, then, based on existing methods, the only procedure to be followed by the UE may be to release its 5G UE context related to 5G cell1 and start a new call setup on 4G cell2. This is what is referred to below as the first option.

However, another approach proposes an alternative procedure to be followed by the UE after it loses its radio coverage from a serving cell, cell1, running on a first RAT, RAT1, e.g., 5G, and detects a radio coverage from a neighboring cell, cell2, running on another RAT, e.g., 4G.

The alternative option referred to below as the second option, may comprise that, after the UE loses radio coverage from its serving cell1 of RAT1, e.g., 5G cell1, and detects radio coverage from cell2 of RAT2, e.g., 4G cell2, then, the UE may make a decision to select one of two procedures. According to the first option, the UE may release the 5G UE context of cell1 and immediately trigger a new call setup on cell2 of RAT2, as may be performed in existing methods. According to the second option, the UE may camp on the 4G cell2, but not trigger a new call setup, but rather wait for a period≥T in order to reconnect to the 5G cell1 and then trigger a call reestablishment on cell1.

This alternative procedure just described may be understood only to be valid when the following two conditions are met: a) the value of T is known, where T may be understood to be the period during which the radio coverage of the serving cell, 5G cell1 in the example, is absent/lost, and b) when the UE verifies certain UE conditions. In one example of UE conditions, the UE may compare the value of the RAT on serving cell1, before it loses its radio coverage, and the value of RAT on the second cell2 that may be detected after cell1 is lost.

If the UE that is being served by cell1 before it loses its radio coverage is running a communication, e.g., the UE was having a download of a video or file, e.g., video1, at 80% when cell1 outage occurs, then, according to the first option of existing methods described above, and following the example provided, the UE may release the communication on 5G cell1. That is, the UE may release the downloaded 80% of video1 and start from scratch a new call setup on 4G cell2 where video1 has to be downloaded from scratch.

Advantageously, according to the second option of existing methods described above, when certain conditions may be validated, e.g., when cell1 and cell2 are running on different RATs, the UE may camp on cell2 but may not trigger further any signaling procedure on cell2. Rather, the UE may wait for a period T and reconnect to cell1 via a call reestablishment procedure. As a consequence, the communication that was running on cell1, video1 in the example, may be resumed on cell1 at 80%.

According to the alternative procedure described above, the value of T may be only estimated in cases where cell1 may lose its radio coverage due to a planned cell outage. However, there may be few scenarios where the UE may lose radio coverage without having a knowledge on the value of T as it may have been the case for a planned outage, e.g., a subscriber passing a radio coverage hole at one particular location X of serving cell1.

When a UE executes the second option of existing methods described above, the main signaling procedure triggered by the UE may be understood to be the call reestablishment procedure, described next.

### Call Reestablishment Procedure

Based on 3GPP standards, in particular in specification TS 38.331, v. 16.10.0, Radio Resource Control (RRC), when a UE, e.g., UE1, which is in communication with a serving 5G cell, e.g., cell1, loses its radio coverage from cell1, a timer, called T311, may then be started at the cell1 and at the UE1, and during the period of that timer, the call context of UE1 may be held at cell1 and at UE1. Then the UE1 may have to: 1) go to idle mode after the expiry of T311 , and 2) find a suitable cell, before the expiry of T311. There may be then two scenarios. According to a first scenario, UE1 may find a 5G suitable cell which may be either the previous serving cell1, or another neighboring 5G cell. In such a scenario, UE1 may trigger a signaling procedure, denoted call reestablishment procedure, where the 5G call may be resumed, within a very short period, e.g., X milliseconds (ms), on cell1 or on any neighboring 5G cell. According to a second scenario, UE1 may find a suitable cell on a RAT different than the serving 5G RAT, e.g., on 4G or 3G or 2G etc . . . , In such a scenario, UE1 may have to execute the following two actions: a) drop the existing 5G call, and b) trigger a new call setup procedure on a new RAT. The duration of such call setup procedure may depend on which RAT the UE1 may have triggered the call setup. In all cases, whatever the target RAT may be, the duration of the call setup may be understood to be bigger than the duration of the call reestablishment. In following paragraphs, the duration of the call setup of UE1 on another RAT is denoted as Y seconds.

The values of T311 as in 3GPP 38.331, v. 16.10.0 are shown in Table 1.

TABLE 1

| | |
|---|---|
| RLF-TimersAndConstants ::= | SEQUENCE |

| | |
|---|---|
| t310 | ENUMERATED (ms0, ms50, ms100,ms200, ms1000, ms2000, ms4000, ms 6000), |
| n310 | ENUMERATED (n1, n2, n3, n4, n6, n8, n10, n20), |
| n311 | ENUMERATED (n1, n2, n3, n4, n5, n6, n8, n10), |
| ..., | ENUMERATED (ms1000, ms3000, ms5000, ms10000, ms15000, ms20000, ms30000) |

```
  [[
  t311
  ]]
}
```

Existing methods to address out of coverage scenarios may result in a release of an existing communication, wasted radio and energy resources, as well as long latencies, resulting in poor user experience.

### SUMMARY

As part of the development of embodiments herein, one or more challenges with the existing technology will first be identified and discussed.

A first problem identified with existing methods may arise in scenarios where a UE may experience an out-of-coverage outage for the first time at a certain location X. In every wireless network, there may be some scenarios where the UE may experience radio coverage loss of a serving cell1 at one location X for the first time. According to a first scenario, Scenario 1, a serving cell1 may go down, unexpectedly, due to a software or a hardware failure. According to a second scenario, Scenario 2, the UE may encounter for the first time a radio coverage hole in the network, e.g., the UE may pass by a new location Y where there is an out-of-coverage outage that was not reported before to the network.

In such scenarios, as the UE is passing for the first time by a location X, then based on existing methods, there is no method either on the network side, that may calculate the value of T at location X, and then pass it beforehand to the UEs that may be heading towards location X.

This is a problem with the existing methods because, without knowledge of the value of T, when the UE loses its radio coverage on serving cell1, e.g., 5G cell1, and detects a radio coverage from a neighbor cell, cell2, on another RAT, e.g., 4G cell2, the UE may, according to existing methods, release its communication on cell1, e.g., 80% of a downloaded file, and may trigger a new call, that is, a new download, from scratch, on the new cell, e.g., 4G cell2. This problem becomes even more relevant when the RAT of the second cell may be of lower performance that the RAT of the first cell.

A second problem identified with existing methods may arise in scenarios where multiple UEs may have already experienced a radio degradation at location X. When a radio degradation occurs at one location X of the network, then, for the first UE that may pass by location X, the first problem just described may be understood to be encountered. However, if multiple UEs have already passed by location X, either the same UE or different UEs, then based on existing standard procedures, these UEs may report the radio degradation at location X, and the network may build an estimation about the size of the degraded area at location X based on the reported information. However, even if enough information may be reported by the multiple UEs that pass by the same location X, there is no method in existing approaches that may calculate and then communicate the value of T to the UE. Such method do not exist neither on the network side, nor on the UE side.

This is a problem with the existing methods because, without knowledge of the value of T, when the UE loses its radio coverage on the serving cell1, e.g., 5G cell1, and detects a radio coverage from a neighbor cell, cell2, on another RAT, e.g., 4G cell2, the UE may release its communication on cell1, e.g., 80% downloaded file, and may trigger a new call, that is, a new download, from scratch, on 4G cell2.

According to the foregoing, it is an object of embodiments herein to improve the handling of a future outage of coverage in a wireless communications network.

According to a first aspect of embodiments herein, the object is achieved by a method, performed by a wireless device. The method is for handling a future outage of coverage. The wireless device operates in a wireless communications network. The wireless device determines, wherein the future outage of coverage is unplanned and a duration of time of the future outage of coverage is unknown, an estimation. The estimation is of a time of duration of the outage of coverage. The wireless device then determines, after experiencing the outage of coverage at a first cell, whether or not to initiate a new connection setup to a second cell, based on the determined estimation.

According to a second aspect of embodiments herein, the object is achieved by a method, performed by a network node. The method is for handling the future outage of coverage. The network node operates in the wireless communications network. The network node determines, wherein the future outage of coverage is unplanned and the duration of time of the future outage of coverage is unknown, the estimation of the time of duration of the outage of coverage. The network node also sends one or more first indications to the wireless device operating in the communications network. The one or more first indications indicate the determined estimation.

According to a third aspect of embodiments herein, the object is achieved by the wireless device, for handling the future outage of coverage. The wireless device is configured to operate in the wireless communications network. The wireless device node is further configured to determine, wherein the future outage of coverage is unplanned and the duration of time of the future outage of coverage is unknown, the estimation of the time of duration of the outage of coverage. The wireless device is also configured to determine, after experiencing the outage of coverage at the first cell, whether or not to initiate the new connection setup to the second cell, based on the estimation configured to be determined.

According to a fourth aspect of embodiments herein, the object is achieved by the network node, for handling the future outage of coverage. The network node is configured to operate in the wireless communications network. The network node is further configured to determine, wherein the future outage of coverage is unplanned and the duration of time of the future outage of coverage is unknown, the estimation of the time of duration of the outage of coverage. The network node is also configured to send the one or more first indications to the wireless device configured to operate in the communications network. The one or more first indications are configured to indicate the estimation configured to be determined.

By determining the estimation of the time of duration of the unplanned outage of coverage, the wireless device may then be enabled to use this estimation to decide whether or not to initiate a new connection setup to the second cell, based on the determined estimation, or whether to wait for the first cell to come back up. Avoiding establishing a whole new connection with the second cell may be understood to have advantages in terms of latency of potential Quality of Service (QoS), as will be further explained later.

By the wireless device determining, after experiencing the outage of coverage at the first cell, whether or not to initiate the new connection setup to the second cell, based on the determined estimation, the wireless device may be enabled, when it may lose its radio coverage from the first cell, e.g., of a first low latency RAT, e.g. 5G cell1, to take the best decision on whether to a) perform the new call setup on the second cell of, e.g., a second higher latency RAT, e.g. 4G cell2, or b) wait for a period of time in order to reestablish the connection on the first cell of the first RAT. This may be understood to bring many advantages.

A first advantage may be for the communication. The determining of whether or not to initiate the new connection setup may be understood to prevent the wireless device from performing immediately a connection on the second cell of the second RAT whenever there may be a chance for a quick return to first cell of first RAT. This may in turn bring two further advantages.

A first further advantage may be that the running connection on the first cell, e.g., the 5G cell1, may not be dropped. This may be understood to be particularly relevant whenever the subscriber may be experiencing an emergency situation, for example, if the subscriber has dialed emergency call 911 on the first cell, e.g., 5G cell1. In another example, the subscriber may be involved in a remote health operation and while downloading a video, the wireless device may lose the radio coverage from the serving first cell, e.g., 5G cell1, while being at the end of the download, e.g. at 80% of the download. According to existing methods, in the first example, the emergency call is dropped, and the subscriber has to initiate a long connection setup from scratch on the second cell, e.g., 4G cell2. In the second example, the download video is released at 80% and the UE has to initiate a new connection setup to the second cell, e.g., 4G cell2, where the UE has to download the previously dropped video from scratch. As a result, in both examples, the drop of the communication will have a bad impact on the subscriber. In contrast, according to embodiments herein, in the first example, the emergency call may not be dropped, and in the second example, the download may be resumed at 80% on the initial low latency serving RAT.

A second further advantage may be that the period of the degradation of the connection may be less whenever the wireless device may wait and reestablish its connection on the first cell, e.g., of the first RAT, in comparison to existing methods, where the UE moves to the second cell, e.g., of the second RAT. This may be understood to stem from the fact that the duration of a connection reestablishment procedure may always be shorter than the duration of a new connection setup.

The advantages provided by the network node performing the determining of the estimation, and the sending the one or more first indications to the wireless device may be understood to be the same as those described for the wireless device, since the network node may, in some embodiments provide its own estimation to the wireless device, or other information enabling the wireless device to determine the estimation itself, e.g., by providing assistance information.

### BRIEF DESCRIPTION OF THE DRAWINGS

Examples of embodiments herein are described in more detail with reference to the accompanying drawings, and according to the following description.

FIG. 1 is a schematic diagram illustrating a wireless communications network, according to embodiments herein.

FIG. 2 is a flowchart depicting an example of a method performed by a wireless device, according to embodiments herein.

FIG. 3 is a flowchart depicting an example of a method in a network node, according to embodiments herein.

FIG. 4 is a schematic representation depicting a non-limiting example of some aspects of methods according to embodiments herein.

FIG. 5 is a schematic block diagram illustrating a non-limiting example of a wireless device, according to embodiments herein.

FIG. 6 is a schematic block diagram illustrating a non-limiting example of a network node, according to embodiments herein.

### DETAILED DESCRIPTION

Certain aspects of the present disclosure and their embodiments may provide solutions to the challenges described in the Summary section, or other challenges. There are, proposed herein, various embodiments which address one or more of the issues disclosed herein.

Embodiments herein may be understood to relate to methods to estimate the period of unexpected outage for a first UE and following UEs that may pass by a degraded area.

Some of the embodiments contemplated will now be described more fully hereinafter with reference to the accompanying drawings, in which examples are shown. In this section, the embodiments herein will be illustrated in more detail by a number of exemplary embodiments. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art. It should be noted that the exemplary embodiments herein are not mutually exclusive. Components from one embodiment may be tacitly assumed to be present in another embodiment and it will be obvious to a person skilled in the art how those components may be used in the other exemplary embodiments.

Note that although terminology from LTE/5G has been used in this disclosure to exemplify the embodiments herein, this should not be seen as limiting the scope of the embodiments herein to only the aforementioned system. Other, newer, wireless systems with similar features, may also benefit from exploiting the ideas covered within this disclosure.

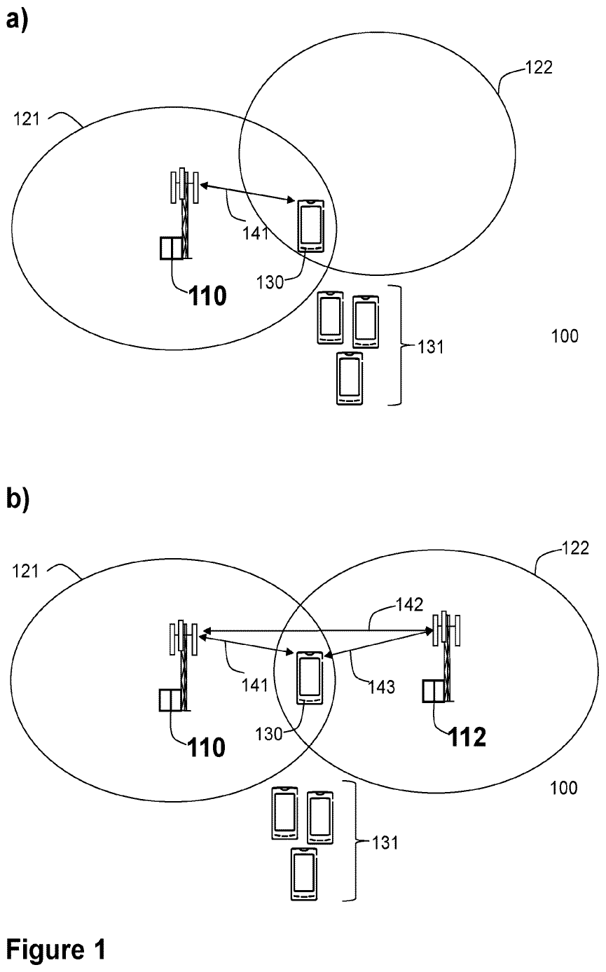

FIG. 1 depicts two non-limiting examples, on panel a) and panel b), respectively, of a wireless communications network 100, sometimes also referred to as a communications network, wireless communications system, cellular radio system, or cellular network, in which embodiments herein may be implemented. The wireless communications network 100 may typically be a 5G system, 5G network, NR-U or Next Gen System or network, LAA, MulteFire. The wireless communications network 100 may support a newer system than a 5G system, such as, for example a 6G system. The wireless communications network 100 may support other technologies, such as, for example Long-Term Evolution (LTE), LTE-Advanced/LTE-Advanced Pro, e.g. LTE Frequency Division Duplex (FDD), LTE Time Division Duplex (TDD), LTE Half-Duplex Frequency Division Duplex (HD-FDD), LTE operating in an unlicensed band, etc . . . , Other examples of other technologies the communications network 100 may support may be Wideband Code Division Multiple Access (WCDMA), Universal Terrestrial Radio Access (UTRA) TDD, Global System for Mobile Communications (GSM) network, Enhanced Data Rates for GSM Evolution (EDGE) network, GSM EDGE Radio Access Network (GERAN) network, Ultra-Mobile Broadband (UMB), network comprising of any combination of Radio Access Technologies (RATs) such as e.g. Multi-Standard Radio (MSR) base stations, multi-RAT base stations etc., any 3rd Generation Partnership Project (3GPP) cellular network, WiFi networks, Worldwide Interoperability for Microwave Access (WiMax), IoT, Narrowband Internet of Things (NB-IoT), or any cellular network or system. Thus, although terminology from 5G/NR and LTE may be used in this disclosure to exemplify embodiments herein, this should not be seen as limiting the scope of the embodiments herein to only the aforementioned systems.

The wireless communications network 100 comprises a network node 110, as depicted in panel a) and panel b) of FIG. 1. It may be understood that the wireless communications network 100 may comprise additional network nodes. As for example depicted in panel b) of FIG. 1, the wireless communications network 100 may comprise a second network node 112. Any of the network node 110 and the second network node 112 may be a radio network node, that is, a transmission point such as a radio base station, for example a gNB, an eNB, or any other network node with similar features capable of serving a wireless device, such as a user equipment or a machine type communication device, in the wireless communications network 100. In other examples, which are not depicted in FIG. 1, any of the network node 110 and the second network node 112 may be a distributed node, such as a virtual node in the cloud, and may perform its functions entirely on the cloud, or partially, in collaboration with a radio network node. In some examples, any of the network node 110 and the second network node 112 may be a core network node.

The wireless communications network 100 covers a geographical area which may be divided into cell areas, wherein each cell area may be served by a network node, although, one radio network node may serve one or several cells. The wireless communications network 100 comprises a first cell 121, which may be served by the network node 110, as schematically represented in FIG. 1. The wireless communications network 100 also comprises a second cell 122, which, in some embodiments, as depicted in panel a) of FIG. 1, may be served by the network node 110, while in other embodiments, as depicted in panel b) of FIG. 1, may be served by the second network node 112. Any of the network node 110 and the second network node 112, may serve additional cells. This is not depicted in FIG. 1 to simplify the figure. Any of the network node 110 and the second network node 112 may be of different classes, such as, e.g., macro base station, home base station or pico base station, based on transmission power and thereby also cell size.

Any of the network node 110 and the second network node 112 may support one or several communication technologies, and their name may depend on the technology and terminology used. In 5G/NR, any of the network node 110 and the second network node 112 may be referred to as a gNB and may be directly connected to one or more core networks.

A wireless device 130 may be comprised in the wireless communication network 100. In some embodiments, such as the example depicted in panel b) of FIG. 1, the wireless communications network 100 may comprise one or more first wireless devices 131. The one or more first wireless devices 131 are represented with three first wireless devices 131 in FIG. 1. However, this may be understood to be for illustration purposes only. The one or more first wireless devices 131 may comprise further or fewer first wireless devices than those depicted. It may be understood that the wireless communications network 100 may comprise additional wireless devices. Any of the wireless device 130 and the one or more first wireless devices 131 comprised in the wireless communications network 100 may be a wireless communication device, which may also be known as e.g., mobile terminal, wireless terminal and/or mobile station, a mobile telephone, cellular telephone, or laptop with wireless capability, just to mention some further examples. The wireless device 130 comprised in the wireless communications network 100 may be, for example, portable, pocket-storable, hand-held, computer-comprised, or a vehicle-mounted mobile device, enabled to communicate voice and/or data, via the RAN, with another entity, such as a server, a laptop, a Personal Digital Assistant (PDA), or a tablet, Machine-to-Machine (M2M) device, device equipped with a wireless interface, such as a printer or a file storage device, modem, or any other radio network unit capable of communicating over a radio link in a communications system. In particular embodiments, any of the wireless device 130 and the one or more first wireless devices 131 may be a user equipment, such as a 5G UE or nUE, or a UE. Any of the wireless device 130 and the one or more first wireless devices 131 comprised in the wireless communications network 100 is enabled to communicate wirelessly in the wireless communications network 100. The communication may be performed e.g., via a RAN, and possibly the one or more core networks, which may be comprised within the wireless communications network 100.

In some examples, the wireless communications network 100 may include a telecommunication network that may include an access network, such as a radio access network (RAN), and a core network, which may include one or more core network nodes. The access network may include one or more access network nodes, such as the network node 110 and the second network node 112, e.g., which may be generally referred to as network nodes, or any other similar 3rd Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes may include disaggregated implementations or portions thereof. For example, in some embodiments, the telecommunication network may include one or more Open-RAN (ORAN) network nodes. An ORAN network node is a node in the telecommunication network that supports an ORAN specification, e.g., a specification published by the O-RAN Alliance, or any similar organization, and may operate alone or together with other nodes to implement one or more functionalities of any node in the telecommunication network, including one or more network nodes and/or core network nodes.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller, near-real time or non-real time, hosting software or software plug-ins, such as a near-real time control application, e.g., xApp, or a non-real time control application, e.g., rApp, or any combination thereof, the adjective “open” designating support of an ORAN specification. Any of the network node 110 and the second network node 112 may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment, in which one or more network functions may be virtualized. For example, the virtualization environment may include an O-Cloud computing platform orchestrated by a Service Management and Orchestration Framework via an O-2 interface defined by the O-RAN Alliance or comparable technologies. Any of the network node 110 and the second network node 112 may facilitate direct or indirect connection of user equipment (UE), such as by connecting the wireless device 130 to the core network over one or more wireless connections.

The wireless device 130 may be configured to communicate within the wireless communications network 100 with the first network node 110 in the first cell 121 over a first link 141, e.g., a radio link. The network node 110 and the second network node 112 may be configured to communicate within the wireless communications network 100 over a second link 142, e.g., a wired link, a radio link or an X2 interface. The wireless device 130 may be configured to communicate within the wireless communications network 100 with the second network node 112 in the second cell 122 over a third link 143, e.g., a radio link. Any of the first wireless device 131 may be configured to communicate within the wireless communications network 100 with the network node 110 in the first cell 121 over a respective fourth link, e.g., a radio link, and with the second network node 112 in the second cell 122 over a respective fifth link, e.g., a radio link. This is not depicted in FIG. 1 to simplify the Figure.

In general, the usage of “first”, “second”, “third”, “fourth” and/or “fifth” herein may be understood to be an arbitrary way to denote different elements or entities, and may be understood to not confer a cumulative or chronological character to the nouns they modify.

Several embodiments are comprised herein. It should be noted that the examples herein are not mutually exclusive. Components from one embodiment may be tacitly assumed to be present in another embodiment and it will be obvious to a person skilled in the art how those components may be used in the other exemplary embodiments.

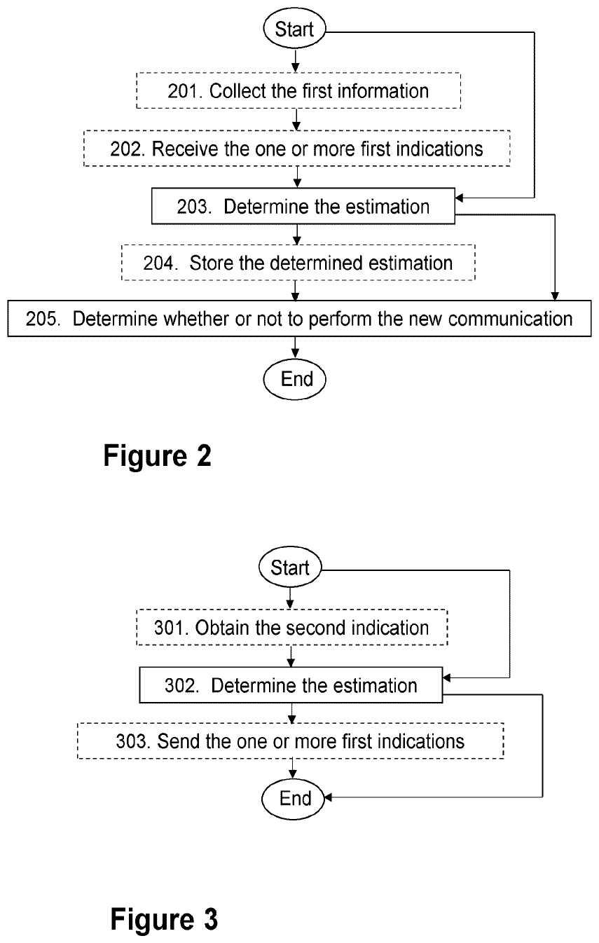

Embodiments of a method performed by the wireless device 130 will now be described with reference to the flowchart depicted in FIG. 2. The method may be understood to be for handling a future outage of coverage. An outage of coverage may be understood herein as a loss of radio coverage. The future outage of coverage may be to be experienced by e.g., the wireless device 130. The wireless device 130 operates in the wireless communications network 100.

The wireless communications network 100 may be a Fifth Generation network.

Several embodiments are comprised herein. In some embodiments all the actions may be performed. In some embodiments, two or more actions may be performed. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. A non-limiting example of the method performed by the wireless device 130 is depicted in FIG. 2.

In FIG. 2, actions which may be optional are depicted with dashed boxes.

### Action 201

Embodiments herein may be understood to aim at handling a future outage of coverage which is unplanned. Particularly, embodiments herein may be understood to aim at estimating a value of a duration of time of the future outage of coverage, which may be referred to herein as “T”. Since the outage of coverage is unplanned, this duration of the time of the future outage of coverage may be understood to be a priori unknown.

In order to ultimately estimate the value of the duration of time of the future outage of coverage, in some embodiments, the wireless device 130 may, in this Action 201, collect first information.

Collecting may be understood as obtaining, receiving, detecting, storing, logging etc.

The first information may be collected by the wireless device 130 after a previous occurrence of the outage of coverage. This Action 201 may be performed whenever the wireless device 130 may encounter a radio degradation at one location X for the first time. For example, the previous occurrence may be whenever the wireless device 130 may encounter a radio degradation for the first time of the radio coverage from the first cell 121, e.g., its serving cell of RAT1, denoted event1, at one location of the wireless communications network 100.

The first information may comprise a first location of the previous occurrence of the outage of coverage. For example, the wireless device 130 may calculate the coordinates of location X, via Global Positioning System (GPS), via radio fingerprint or via any other existing procedure.

In some embodiments, additionally or alternatively, the first information may comprise a first time of occurrence of a loss of radio coverage with the first cell 121 at the previous occurrence of the outage of coverage. For example, the wireless device 130 may collect the timestamp, denoted UE_stamp1, when the wireless device 130 may have lost the radio coverage from the first cell 121.

In some embodiments, additionally or alternatively, the first information may comprise a second time of occurrence of a triggering of a connection setup to the second cell 122 during the outage. A connection setup may be understood as a new call setup, e.g., on the second cell 122, for example, of RAT2. For example, the wireless device 130 may collect the timestamp, denoted UE_stamp2, when the wireless device 130 may have triggered a call setup at the second cell 122 of RAT2.

In some embodiments, the first cell 121 may operate on a different RAT than the second cell 122.

In some embodiments, additionally or alternatively, the first information may comprise a third time of occurrence of regain of radio coverage with the first cell 121. For example, the wireless device 130 may collect the timestamp, denoted UE_stamp3, when the wireless device 130 may find again radio coverage from the first cell 121 of RAT1 and hence may send a RRC radio measurement to the second cell 122 of RAT2 in order to trigger a handover procedure from the second cell 122 of RAT2 to the first cell 121 of RAT1. Such handover procedure may be expected because it may be assumed that the first cell 121, serving RAT1, e.g. 5G, may have a higher priority than RAT2, and the wireless device 130 may have to camp always on the RAT with the highest priority.

In some embodiments, additionally or alternatively, the first information may comprise a velocity of the wireless device 130 during the previous occurrence of the outage of coverage. The wireless device 130 may estimate its velocity via any existing method.

By collecting the first information, the wireless device 130 may then enable to use this first information to determine an estimation of the time of duration of the future outage of coverage, either itself, in Action 203, or by providing it to the network node 110, which may then perform the estimation, in Action 302. Either way, the estimation of the time of duration of the future outage of coverage, may then enable the wireless device 130 to decide, whenever the outage of coverage may happen, whether or not to initiate a new connection setup to the second cell 122, based on the determined estimation, or whether to wait for the first cell 121 to come back up. Avoiding establishing a whole new connection with the second cell 122 may be understood to have advantages in terms of latency of potential Quality of Service (QoS), as will be further explained later.

### Action 202

In this Action 202, the wireless device 130 may receive one or more first indications from the network node 110. The receiving in this Action 202 may be via broadcasting or dedicated signalling. The receiving in this Action 202 may be performed via the first link 141.

The receiving via broadcasting may be via one broadcasted System Information Block (SIB) on the air interface.

The one or more first indications may indicate one of the following. According to a first option, the one or more first indications may indicate a predetermined static value of the duration of time of the future outage of coverage. While the duration of the future outage is unknown, the network node 110 may give a fixed, predetermined value to the duration.

The pre-determined value may be based on at least one of: a category of the wireless device 130, and one or more properties of a power supply of the wireless device 130. The category of the wireless device 130 may be, e.g., enhanced Mobile Broadband (eMBB), smartphone, IoT, Reduced Capacity (RedCap), Ultra-Reliable Low Latency Communications (URLLC), Extended Reality (XR), etc. The one or more properties of the power supply of the wireless device 130 may comprise: an indication of being connected to a fixed cable power supply, an indication of being supplied by a battery, optionally including, an indication of the amount of battery left in percentage, e.g., 10%, 50%, 90%, an indication of the absolute amount of energy left in battery, e.g., megajoule, etc . . . ,

According to a second option, the one or more first indications may indicate second information derived or obtained from one or more first wireless devices 131 operating in the wireless communications network 100. The one or more first wireless devices 131 may be understood to have been other wireless devices which may have experienced the radio degradation at location X, e.g., at the first cell 121. The one or more first wireless devices 131 may include or exclude the wireless device 130.

According to a third option, the one or more first indications may indicate an estimation of the time of duration of the outage of coverage. That is, a calculated value, e.g., T, which may be understood as a predicted value of the time duration of the outage of coverage. This option may be understood to correspond to embodiments wherein the network node 110 have for example, performed the estimation of the time of duration itself. The details on how the network node 110 may perform this estimation are provided in relation to Action 302. After obtaining the estimation of the time of duration of the outage of coverage, that is, the value of T, the network node 110 may convey that value, together with other information, to the wireless device 130. In order to do so, in some embodiments, the one or more first indications may indicate at least one of: i) a presence of the outage of coverage, ii) a location, referred to herein as a “second” location, where the unplanned outage of coverage may be estimated to be experienced at, iii) a length of the unplanned outage, and iv) a confidence interval of the estimation, as determined by the network node 110.

The one or more indications i-iii in the previous paragraph may be understood as three new parameters that may need to be added to the current 3GPP 38.331, v. 16.10.0 specification for the RRC protocol. The first parameter, the presence of the outage of coverage, that is, of the radio coverage loss, may be coded, for example, in 1 bit. If equal to 1, then the wireless device 130 may read the following two new parameters. Otherwise, if 0, the wireless device 130 may refrain from reading them.

The second parameter, the so called herein “second” location, e.g., X, may be understood as a geographical coordinate or a radio fingerprint that may inform the wireless device 130 of where it may experience the future loss of radio coverage.

The third parameter, the length of the outage, which may be understood as the value of T calculated by the network node 110, which may reflect the period of the expected duration where the wireless device 130 may experience the radio coverage loss.

In case the estimation T may be a predicted value, the network node 110 may also signal the associated confidence interval of the prediction. For example, the outage period may be T +-ß, where ß may be may be, for example, the standard deviation of the prediction, or in another example, the confidence of the value being in a certain range of T. For example, value of T is with a 90% confidence in [T−ß, T+ß] range. The confidence value, e.g., 90%, may be signalled along with the value of T, and ß.

In some examples, the receiving via broadcasting may be via one SIB on the air interface, by sending the three new parameters listed above in one SIB.

In some examples, the procedure to receive the one or more first indications from the network node 110 in this Action 202 may be performed only when the value of the parameter presence of a radio coverage loss, described above, may be set to the value of 1. If the value of this parameter is 0, that may be understood to mean that there is no radio coverage hole, nor a unplanned outage in the network

According to a fourth option, the one or more first indications may indicate assistance information. The assistance information may enable the wireless device 130 to derive the estimation of the time duration. The assistance information may also be used by the wireless device 130 to improve the decision of whether to change to another RAT, as will be described in Action 205.

In some embodiments, the assistance information may comprise one of the following. In some embodiments, the assistance information may comprise historical information. That is, historical information on statistics of previous coverage outages. The statistic information may be divided into different categories. In some embodiments the historical information may comprise at least one of: location information, device information, and mobility information. The location information may comprise e.g., radio information, such as the device serving Synchronization Signal Block (SSB), or Channel State Information Reference Signal (CSI-RS), and/or geolocation, such as that provided, for example, by the Global Navigation Satellite System (GNSS). The device information may comprise, e.g., a manufacturer of respective device which may have experienced the prior outage, that is, of the respective first wireless device 131. The device information may comprise e.g., device model, chipset vendor, chipset model, UE category, e.g., NR performance capability, UE category, e.g., eMBB, smartphone, IoT, RedCap, URLLC, XR, etc. The mobility information may comprise, e.g., trajectory information, sequence of radio or geolocation.

The statistics, for each potential category, may comprise, e.g., a minimum, maximum and/or average outage time, and/or time upon reconnection on the same RAT. The statistics, for each potential category may, additionally and/or alternatively, comprise, e.g., a fraction of successful reconnections, for example x % of first wireless devices 131 which may reconnect to the same RAT.

The wireless device 130 may use such information to get an estimate of the typical outage time in its current serving cell, in examples herein, the first cell 121. The information above may be broadcasted, or in a unicast transmission based, on the device information and its current location information.

In some embodiments, the assistance information may comprise reconnection information to be used by the wireless device 130 when out of coverage. The reconnection information to be used by the wireless device 130 when out of coverage may comprise elements in the System Information Bits indicating how the wireless device 130 may need to perform cell reselection. For example, signal quality thresholds for controlling which cells the wireless device 130 may need to connect to.

According to a fifth option, the one or more first indications may indicate a location, which may be referred to herein as a “third” location, where the wireless device 130 may have to fetch the estimation of the time of duration of the outage of coverage or the assistance information. According to this fifth option, the one or more first indications may lack the estimation or the assistance information. The third location information may be, for example, an address of an external server the wireless device 130 may have to connect to in order to collect the estimation or the assistance information from the server. For example, the third location may be an Internet Protocol (IP) address of the server where the estimation, or the assistance information estimation about T, such as location X of area1, or type of outage, etc. may be collected. For example, when the wireless device 130 is in connected mode, an indication in one SIB about the existence of some information related to the out of coverage may be sent to and obtained by the wireless device 130.

In order to collect the estimation or the assistance information from the external server rather than from the SIB, two new parameters may be added as follows. One of the one or more first indications may be a first additional parameter, which may be a new parameter, indicating whether the estimation or the assistance information may be sent a) via broadcasted on SIB, or b) may have to be collected on the external server. If the value is equal to 1, then the estimation or the assistance information may be sent via broadcasted on SIB. Otherwise, if the value of this parameter is 0, then the estimation about T or the assistance information may have to be collected by the wireless device 130 in connected mode via the external server, which IP address may be defined by a second additional parameter. The second additional parameter may be the IP address of the server.

By receiving the one or more first indications in this Action 202, the wireless device 130 may then be enabled to use this first information to determine the estimation of the time of duration of the future outage of coverage in the next Action 203, either as determined by the network node 110 in Action 302, or as estimated by the wireless device 130 itself. Either way, the estimation of the time of duration of the future outage of coverage, may then enable the wireless device 130 to decide, whenever the outage of coverage may happen, whether or not to initiate a new connection setup to the second cell 122, based on the determined estimation, or whether to wait for the first cell 121 to come back up. Avoiding establishing a whole new connection with the second cell 122 may be understood to have advantages in terms of latency of potential Quality of Service (QoS), as will be explained later in further detail.

### Action 203

In this Action 203, the wireless device 130 determines, wherein, as explained earlier, the future outage of coverage is unplanned and the duration of time of the future outage of coverage is unknown, the estimation of the time of duration of the outage of coverage, e.g., the value T.

Determining may be understood as e.g., calculating, checking, estimating, predicting, etc.

The determining in this Action 203 of the estimation may be based on one of the following. In some embodiments, the determining in this Action 203 of the estimation may be based on the first information collected in Action 201 by the wireless device 130 after the previous occurrence of the outage of coverage. This may be understood to be a new functionality on the side of the wireless device 130, which may calculate the value of T in case the wireless device 130 may move more than once by the same location of out-of-coverage. The objective of the estimation based on the first information may be understood to be to let the UE know the value of T without any assistance from the network, e.g., from the network node 110. After the wireless device 130 may encounter a radio degradation, e.g., an out-of-coverage outage, at one location X of a serving cell of RAT1, e.g., the first cell 121, it may detect the second cell 122, e.g., of another RAT2, as the best cell suitable cell.

The determining in this case in this Action 203 may comprise two prerequisites. A first prerequisite may be a smart functionality. The smart functionality may be implemented on the side of the wireless device 130. The smart functionality may be understood to have the role of calculating and/or predicting the estimation of the time of duration, e.g., the duration, T, during which the wireless device 130 may experience the future loss of radio coverage at one, or more, particular location(s). An example is given in below under the heading “Example: how the wireless device 130 may calculate the estimation of the time of duration, e.g., the value T, without network assistance”.

According to some embodiments, the determining in this Action 203 of the estimation may be performed by one of: a) statistical methods calculations lacking usage of machine-learning methods, and b) using machine-learning to determine a predictive model of the time of duration. In the former, the determining in this Action 203 may be achieved by calculations, e.g., static or non-iterative calculations, such as regression, multivariate analysis etc . . . , In the latter, the determining in this Action 203 may be achieved, e.g., based on Artificial Intelligence (AI) and Machine Learning (ML) and denoted here as “func1”.

A second prerequisite may be that the wireless device 130 may be equipped with the duration of its new connection setup, e.g., call setup, on different RATs. Such duration may be denoted here as T_callsetup. That duration may preferably be part of func1, or it may be delivered to the wireless device 130 by the wireless communications network 100, or via an external server, e.g., the same external server mentioned earlier.

### Example: How the Wireless Device 130 May Calculate the Estimation of the Time of Duration, e.g., the Value T, without Network Assistance

Different methods may be used by func1, implemented on the side of the wireless device 130, in order to calculate the value of T. In one example, whenever the wireless device 130 may encounter a radio degradation for the first time, the radio coverage from the first cell 121, e.g., its serving cell of RAT1, denoted event1, at one location of the wireless communications network 100, it may perform the following actions. In one action, the wireless device 130, according to Action 201, may calculate the coordinates of location X, whether via Global Positioning System (GPS), or via radio fingerprint or any other existing procedure. In another action, also according to Action 201, the wireless device 130 may collect the timestamp, denoted UE_stamp1, when the wireless device 130 may have lost the radio coverage from the first cell 121. In a further action, also according to Action 201, the wireless device 130 may collect the timestamp, denoted UE_stamp2, when the wireless device 130 may have triggered a call setup at the second cell 122 of RAT2. In yet another action, in accordance with Action 201, the wireless device 130 may collect the timestamp, denoted UE_stamp3, when the wireless device 130 may find again radio coverage from the first cell 121 of RAT1 and hence may send a RRC radio measurement to the second cell 122 of RAT2 in order to trigger a handover procedure from the second cell 122 of RAT2 to the first cell 121 of RAT1. Such handover procedure may be expected because it may be assumed that the first cell 121, serving RAT1, e.g. 5G, may have a higher priority than RAT2 and the wireless device 130 may have to camp always on the RAT with the highest priority. As yet a further action, the wireless device 130 may estimate its velocity via any existing method. Thanks to all the collected timestamps, e.g., UE_stamp1, UE_stamp2 and UE_stamp3, and to the velocity of the wireless device 130, func1 may then estimate the size of the distance of the area of loss of coverage that may have been encountered at location X and also the value of T.

In some embodiments, the determining in this Action 203 of the estimation may be based on the predetermined static value of the duration of time, pre-configured at the wireless device 130. That is, the predetermined static value, a default value of T provided in advance, instead of being received from the network node 110, may be hardcoded in the wireless device 130. In these embodiments, no new function may be required to be implemented at the wireless device 130, rather the wireless device 130 may be given the value of T, via a hardcoded value, e.g., proposed by the vendor of the wireless device 130.

In some embodiments, the determining in this Action 203 of the estimation may be based on the one or more first indications received in Action 202 from the network node 110 operating in the wireless communications network 100. In some of these embodiments, no new function may be required either to be implemented at the wireless device 130. Rather, the wireless device 130 may be given the value of T, a default value of T, sent in advance over the air interface via multicast or unicast RRC signaling, and in such a scenario, the value of T may be selected by the operator.

The determining in this Action 203 of the estimation based on the predetermined static value of the duration of time, either as pre-configured at the wireless device 130 or as received in the one or more first indications, may be particularly beneficial when the wireless device 130, being served by e.g., a 5G, or future 6G, first cell 121 may be the first device that may be passing by location X, where a very recent event may have been made, where radio coverage of the first cell 121 may have been lost and the coverage of a higher latency cell, e.g., the second cell 122, e.g., 4G may become the only radio signal at location X. According to existing methods, a UE in such a scenario being the first to pass by location X, may release the communication on the first cell 121, and establish a new connection from scratch on the second cell 122, e.g., 4G cell. Whereas, according to embodiments herein, as the value of T may already be known, the communication may be saved, by a call reestablishment on the 5G first cell 121 or on a neighbor 5G cell, e.g., a third cell. Already having the predetermined static value of the duration of time, may be understood to become very relevant when the wireless device 130 may be running a sensitive application, e.g., an autonomous train carrying many passengers or a doctor performing a remote operation, or a subscriber in accident calling an emergency call 911 etc.

By determining the estimation of the time of duration of the unplanned outage of coverage in this Action 203, the wireless device 130 may then be enabled to use this estimation to decide whether or not to initiate a new connection setup to the second cell 122, based on the determined estimation, or whether to wait for the first cell 121 to come back up. Avoiding establishing a whole new connection with the second cell 122 may be understood to have advantages in terms of latency of potential Quality of Service (QoS), as will be further explained later.

### Action 204

In this Action 204, the wireless device 130 may store the determined estimation in a memory of the wireless device 130. For example, the wireless device 130 may store the estimation of the duration of time it may have estimated after having experienced the previous occurrence of the outage of coverage for the first time, so it may then use the estimation of the time of duration of the outage of coverage the next time it passes by location X.

### Action 205

In this Action 205, the wireless device 130 determines, after experiencing the outage of coverage at the first cell 121, whether or not to initiate a new connection setup to the second cell 122, based on the determined estimation in Action 203.

In some embodiments, the determining in this Action 205 of whether or not to initiate the connection call setup to the second cell 122 may comprise one of: a) refraining from initiating the new connection setup to the second cell 122, and b) initiating the new connection setup to the second cell 122.

After the wireless device 130 may lose its radio coverage from the serving cell, that is, the first cell 121, which may be on RAT1, and if the best cell suitable cell, is the second cell 122 of another RAT2, the wireless device 130, after camping on the second cell 122, may not be disconnected from the network, the wireless device 130 may then take the best decision on whether, according to option b) in the previous paragraph, it may move to the second cell 122 and trigger immediately a call procedure on the second cell 122 of RAT2, or, if according to option a) in the previous paragraph, it camps on the second cell 122, but does not trigger any call procedure on it. Rather, it may wait for a period≥T and then reestablish its connection, e.g., call on the first cell 121 of RAT1.

In some embodiments, the determining in this Action 205 of whether or not to initiate the new connection setup to the second cell 122 may be based on the stored determined estimation. The stored estimation, e.g., the value of T, may be that received from the network node 110 and/or that estimated by the wireless device 130.

Unless the estimation of the duration of time of the future outage of coverage is the predetermined static value, the ‘first time’ the wireless device 130 may experience a radio degradation at location X of serving cell1 of RAT1, as it may be understood to not have a knowledge on the estimated value of T, it may then proceed as in existing methods, that is it may release its communication with the first cell 121 and start a new communication from scratch on the second cell 122, the neighbor of RAT2. However, after that ‘first time’ encounter of degradation at location X, referred to herein as the previous occurrence of the outage of coverage, the wireless device 130 may have an estimate about the value of T, as determined in Action 203.

The next time the wireless device 130 may encounter a radio degradation at the same location X, the wireless device 130, equipped with the value of T determined in Action 203, may then, after it loses its radio coverage from the serving first cell 121 of RAT1, rather than moving directly towards the second cell 122 of RAT2, it may wait for the period≥T and reestablish its connection, e.g., a call, on the first cell 120 of RAT1. As a consequence, two benefits may follow. First, the communication may not be dropped because the wireless device 130 may be understood to not have disconnected from the first cell 121 and may be understood to not have established a new connection setup on the second cell 122 of RAT2. This may be understood to be a significant benefit, especially when the wireless device 130 may be running an emergency or any sensitive communication. The degradation of the communication experienced by the subscriber may also be much less when the wireless device 130 may reestablish the connection on the first cell 121 of RAT1, e.g., 5G, than in the case wherein the wireless device 130 were to establish a new connection on the second cell 122 of RAT2, e.g., 4G.

By knowing the value of T, when the wireless device 130 may lose its radio coverage from one cell, e.g., the first cell 121, and may detect the radio coverage from another cell, the second cell 122, the wireless device 130 may then take a best decision on whether to move immediately to the second cell 122 and trigger a new connection setup on the second cell 122, or camp on the second cell 122 without performing any signaling procedure on the second cell 122, but rather wait for a period≥T to reconnect to the first cell 121.

In some embodiments, the stored estimation may be the value of T, the period of out of coverage, provided by the function described above in relation to Action 203, func1, on the wireless device 130 side.

In some examples wherein the wireless device 130 may have received the one or more first indications from the second network node 110 in Action 202, in this Action 205, the wireless device 130 may, after having determined the estimation in Action 203 as the received estimation, T, take the best decision on whether to wait for the return of coverage of the first cell 121, e.g., of RAT1, or move towards the second cell 122, e.g., of another RAT2.

In embodiments wherein the stored determined estimation may be the predetermined static value, there may be the particular advantage that there may be no need for the one or more first wireless devices 131 to have had to experience the radio degradation at location X in order for the network node 110, or the wireless device 130 to be able to calculate the value T and then forward it to all other wireless devices in the cell. In embodiments wherein the stored determined estimation may be the predetermined static value, even when the wireless device 130 may encounter for the first time a radio degradation at location X, as it may have been given in advance the default value of T, e.g., a few seconds selected by vendor of the wireless device 130 or the operator of the wireless communications network 100, the wireless device 130 may then take a best decision on whether to move immediately to the second cell 122 and trigger a new connection setup on the second cell 122, or to camp on the second cell 122 without performing any signaling procedure on the second cell 122, but rather wait for a period T to reconnect to the first cell 121.

In some embodiments, the determining in this Action 205 of whether or not to initiate the new connection setup to the second cell 122 may be further based on at least one of the following seven options. According to a first option, the determining in this Action 205 may be further based on a) one or more respective parameters of the first cell 121 and the second cell 122. The one or more respective parameters may be, for example, cell radio parameters, e.g., the type of RAT and location area, e.g., a fourth location, on the second cell 122 in comparison to the RAT and location, e.g., a fifth location, on the first cell 121. In one example, if the second cell 122 is of different RAT, e.g., RAT2, than that of the first cell 121, e.g., RAT1, the wireless device 130 may wait for a period T while camping on the second cell 122 before reconnecting to the first cell 121. Whereas if the second cell 122 is of same RAT, RAT1, as the RAT of the first cell 121, and if the location area of the second cell 122, e.g., Tracking Area Code (TAC) 2 (TAC2), is of the same TAC, e.g. TAC1, as the TAC of the first cell 121, then the wireless device 130 may move immediately to the second cell 122, and trigger a signaling procedure on the second cell 122 which may be for example, a call reestablishment procedure.

According to a second option, the determining in this Action 205 may be further based on b) a second indication indicating a time period the wireless device 130 may have to select a cell after the outage, before it may have to go into idle mode. The idle mode may be, e.g., RRC idle mode. The cell may be one of the first cell 121 and the second cell 122. The second indication may be, for example, a value of a timer, such as the T311 timer. The value of T311 may be that received by the wireless device 130 during connection setup. The value of T311 may tell the wireless device 130 how much time it may have to select a cell before the wireless device 130 goes into idle mode.

According to a third option, the determining in this Action 205 may be further based on c) a respective duration of time for initiating the new connection setup in a respective radio access technology. That is, the duration of a new call setup on different RATs. For example, the wireless device 130 may be informed about that duration, either via a preconfigured, hardcoded, value, or via new parameter on SIB information, or via a new parameter on the external server, to be collected together with the estimation or the assistance information estimation. The wireless device 130 may otherwise be informed about that duration, either via func1, e.g., based on historical events. For example, the wireless device 130 may store the average duration of its connection setup on different encountered RATs in the wireless communications network 100.

According to the second and third options, the determining in this Action 205 may be further based on one or more respective values of one or more timers provided to the wireless device 130.

The determining in this Action 205 may be further based on other factors. The next options are examples of such factors.

According to a fourth option, the determining in this Action 205 may be further based on energy consumption considerations. The energy consumption considerations may comprise the energy consumption that may be associated with changing to another RAT. Certain devices may have more efficient RAT switching in terms of energy consumption, or the UEs with low battery level may not afford a RAT switch.

According to a fifth option, the determining in this Action 205 may be further based on service requirements of the wireless device 130. In one example, if the wireless device 130 is a device that may require low-latency, it may initiate the RAT move later than a device with higher accepted latency. In another example, if the wireless device 130 has a video streaming with a lot of data in the buffer, where the network may have buffered the data of the wireless device 130 given an expected coverage hole for the wireless device 130.

According to a sixth option, the determining in this Action 205 may be further based on traffic predictions, e.g., traffic predictions by the wireless device 130. For example, with a prediction model, the wireless device 130 may estimate the probability of data arriving in the downlink/uplink. It may, for example, be the probability of data arriving within the time window T, that is, the expected out of coverage period. The prediction may be based on the history of data transmissions/receptions of the wireless device 130, for example by using any one or more of the following inputs: i) packet inter arrival time, e.g., standard deviation, average . . . , ii) number of packets up/down, iii) total bytes up/down, iv) packet sizes, v) time since last packet, vi) packet protocols, e.g., Hypertext Transfer Protocol (HTTP), voice, etc., vi) manufacturer of the wireless device 130, etc.

According to a seventh option, the determining in this Action 205 may be further based on assistance information obtained from the wireless communications network 100, e.g., from the network node 110. The assistance information may comprise historical information on previous coverage outage statistics.

In some embodiments, the determining in this Action 205 of whether or not to initiate the connection call setup to the second cell 122 may be based on the first information collected by the wireless device 130 on Action 201, e.g., historical information collected from previous coverage outage statistics. In such examples, the wireless device 130 may use, as another input for its decision, its previous experience with one out-of-coverage event, e.g. passing again by same location X.

By the wireless device 130 determining in this Action 205, after experiencing the outage of coverage at the first cell 121, whether or not to initiate the new connection setup to the second cell 122, based on the determined estimation the wireless device 130 may be enabled, when it may lose its radio coverage from the first cell 121, e.g., of a first low latency RAT, e.g. 5G cell1, to take the best decision on whether to a) perform the new call setup on the second cell 122 of, e.g., a second higher latency RAT, e.g. 4G cell2, or b) wait for a period of time in order to reestablish the connection on the first cell 121 of the first RAT. This may be understood to bring many advantages.

A first advantage may be for the communication. The determining in this Action 205 may be understood to prevent the wireless device 130 from performing immediately a connection on the second cell 122 of the second RAT whenever there may be a chance for a quick return to first cell 121 of first RAT. This may in turn bring two further advantages.

A first further advantage may be that the running connection on the first cell 121 5G cell1 may not be dropped. This may be understood to be particularly relevant whenever the subscriber may be experiencing an emergency situation, for example, if the subscriber has dialed emergency call 911 on the first cell 121, e.g., 5G cell1. In another example, the subscriber may be involved in a remote health operation and while downloading a video, the wireless device 130 may lose the radio coverage from the serving first cell 121, e.g., 5G cell1, while being at the end of the download, e.g. at 80% of the download. According to existing methods, in the first example, the emergency call is dropped, and the subscriber has to initiate a long connection setup from scratch on the second cell 122, e.g., 4G cell2. In the second example, the download video is released at 80% and the UE has to initiate a new connection setup to the second cell 122, e.g., 4G cell2, where the UE has to download the previously dropped video from scratch. As a result, in both examples, the drop of the communication will have a bad impact on the subscriber. In contrast, according to embodiments herein, in the first example, the emergency call may not be dropped, and in the second example, the download may be resumed at 80% on the initial low latency serving RAT.

A second further advantage may be that the period of the degradation of the connection may be less whenever the wireless device 130 may wait and reestablish its connection on the first cell 121 of the first RAT, in comparison to existing methods, where the UE moves to the second cell of the second RAT. This may be understood to stem from the fact that the duration of a connection reestablishment procedure may always be shorter than the duration of a new connection setup.

A second advantage of performing the determining of this Action 205 may be that it may provide an approach for the wireless device 130 when it may encounter a degradation for the first time. Existing AI and ML procedures do not work on a UE that encounters a degradation for the first time. Because by nature, they need some input to build their results on it. In contrast, some embodiments herein, wherein the wireless device 130 may use the estimation as the predetermined static value of the duration of time, may allow the wireless device 130 from its first experience of a radio loss from the first cell 121, e.g., the serving cell1, to take the best decision on whether to move immediately on the second cell 122, e.g., cell2, or to wait for a period T to reconnect to the first cell 121, e.g., cell1.

Embodiments of a method, performed by the network node 110, will now be described with reference to the flowchart depicted in FIG. 3. The method may be understood to be for handling the future outage of coverage. The network node 110 operates in the wireless communications network 100.

The wireless communications network 100 may be a Fifth Generation network.

Several embodiments are comprised herein. In some embodiments all the actions may be performed. In some embodiments, two or more actions may be performed. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. A non-limiting example of the method performed by the network node 110 is depicted in FIG. 3. In FIG. 3, actions which may be optional are depicted with dashed boxes. The detailed description of some of the following corresponds to the same references provided above, in relation to the actions described for the network node 110 and will thus not be repeated here. For example, the outage of coverage may be understood herein as a loss of radio coverage.

### Action 301

In this Action 301, the network node 110 may obtain the second information. The second information may be derived or obtained from the one or more first wireless devices 131 operating in the wireless communications network 100.

The second information may comprise at least one of the following. In some embodiments, the second information may comprise first timestamps of signalling messages received from the one or more first wireless devices 131. For example, according to these embodiment, the network node 110 may collect, in this Action 301, timestamps from signaling messages in case of a known radio coverage hole. The timestamps may be of particular signaling messages that may be exchanged during some specific procedures, such as handover or call reestablishment.

As further particular examples of the first timestamps that may be collected in call reestablishment, based on 3GPP standards, in particular on specification 38.331, v. 16.10.0 when a UE in connected mode experiences a radio link failure (RLF) and loses its connection, e.g., denoted call1, with the serving cell1, e.g., the first cell 121, then before expiry of the T311 timer, if the UE detects the radio signal again from the initial cell1 or from any other neighbor cell2, e.g., the second cell 122, of the same RAT of cell1, it may then trigger autonomously, without subscriber notification, a call reestablishment procedure in the network in order to save call1.

When the network node 110 may lose is radio connection with one UE, UE1, in communication on a serving cell1 of RAT1, e.g., the first cell 121, it may, in accordance to Action 301, record a timestamp, stamp_t1. Later, when UE1 may reconnect to the same serving cell1, or to any other neighboring cell2 of the same RAT1 as of cell1, e.g., the second cell 122, the network node 110 may, in accordance to Action 301, register the timestamp, stamp_t2, of the call reestablishment message.

Further particular examples of the first timestamps that may be collected in call handover may be related to the triggering of a handover procedure from one RAT to another RAT, e.g., in the example used above, when a handover procedure may be triggered from the first cell 121, e.g., 5G cell1 to the second cell 122, e.g., a 4G cell2. In such scenario, the network node 110 may, in accordance to Action 301, record the timestamp, stamp_t1, of the RRC measurement message sent by UE1 to the serving cell1 of RAT1 that may contain a handover event, e.g., event A2, that is, when the serving cell may become worse than an absolute threshold. The network node 110 may then, in accordance to Action 301, record the timestamp, stamp_t2, of the RRC message when the UE1 may connect to cell2 of RAT2 during the handover procedure. The network node 110 may also record, in accordance to Action 301, a third timestamp, stamp_t3, when the UE1 may want to return to cell1 of RAT1 after crossing area1.

In other embodiments, the second information may comprise second timestamps of measurement reports received from the one or more first wireless devices 131.

Examples of the second timestamps may be, e.g., the UE values and timestamps of reported RSRP instances, e.g., RSRP in t1, . . . , tn, RSRP in tn+1, tn+2, etc.

In another example, the wireless device 130 may estimate and report its own trajectory to the network node 110. One example of such trajectory report was introduced for drones in Release 15, 3GPP TS 36.331, v. 15.16.0. Capable drones with future location information available may report their flight path during connection setup. The report may comprise a sequence of location-information elements with corresponding time-stamp as shown in Table 2. Table 2 shows an extract of drone flight path parameters from 3GPP 36.331, v. 15.16.0.

TABLE 2

| | |
|---|---|
| FlightPathInfoReport-r15 ::= | SEQUENCE { |

flightpath-r 15 SEQUENCE (SIZE (1..maxWayPoint-r15}} OF WayPointLocation-r-15 OPTIONAL,

| | | |
|---|---|---|
| nonCriticalExtension | SEQUENCE { } | OPTIONAL |

}

| WayPointLocation-r15 ::= | SEQUENCE { | |
|---|---|---|
| waypointLocation-r15 | LocationInfo-r10, | |
| timeStamp-r15 | AbsoluteTimeInfo-r10 | OPTIONAL |

}
-- ASN1STOP

In some embodiments, the second information may comprise a respective velocity of the one or more first devices 131. The speed of the wireless device 130 may be denoted here v_UE.

### Action 302

In this Action 302, the network node 110 may determine, wherein the future outage of coverage is unplanned and the duration of time of the future outage of coverage is unknown, the estimation of the time of duration of the outage of coverage. That is, in this Action 302, the network node 110 may estimate the period of time, T, of the loss of radio coverage that may be experienced by the wireless device 139 at a particular time t1 and/or location X.

Different methods may be used for calculating the value of the estimation.

The determined estimation may be one of: i) the predetermined static value of the duration of time, and ii) derived or obtained from the one or more first wireless devices 131 operating in the wireless communications network 100. The pre-determined value may be based on at least one of: a) the category of the wireless device 130, and b) the one or more properties of the power supply of the wireless device 130.

The determining in this Action 302 of the estimation may be performed, using the second information, by one of: i) the statistical calculations lacking usage of machine-learning methods, and ii) using machine-learning to determine the predictive model of the time of duration.

As a first example, Example 1, of the determination of the estimation in this Action 302 according to the statistical calculations, in some embodiments, the determining in this Action 302 of the estimation may be performed by, after collecting, in accordance to Action 301, timestamps from signaling messages in case of a known radio coverage hole. The period spent for passing a coverage hole, denoted here T_hole, may be known to the network by combining among others, the results of following two types of information. The first type of information may be the speed of the wireless device 130, which may be denoted v_UE. The second type of information may be the timestamps of particular signaling messages that may be exchanged in accordance to Action 301, during some specific procedures, e.g., handover or call reestablishment.

The network node 110 may be aware about a radio coverage hole of one RAT when one of the following two procedures may be triggered.

The first procedure for detecting the radio coverage hole, may take advantage of the procedure based on 3GPP standards, in particular on specification 38.331, v. 16.10.0 according to which, when a UE in connected mode experiences a radio link failure and loses its connection, e.g., denoted call1, with the serving cell1, e.g., the first cell 121, then before expiry of the T311 timer, if the UE detects the radio signal again from the initial cell1 or from any other neighbor cell2, e.g., the second cell 122, of the same RAT of cell1, it may then trigger autonomously, without subscriber notification, a call reestablishment procedure in the network in order to save call1. Based on this, one way for the network node 110 to detect a radio coverage hole in the wireless communications network 100 may be to detect the triggering of a call reestablishment procedure. One example of calculating the period T_hole during a call reestablishment procedure may be as follows. When the network node 110 may lose is radio connection with one UE, UE1, in communication on a serving cell1 of RAT1, e.g., the first cell 121, it may, in accordance to Action 301, record a timestamp, stamp_t1. Later, when UE1 may reconnect to the same serving cell1, or to any other neighboring cell2 of the same RAT1 as of cell1, e.g., the second cell 122, the network node 110 may, in accordance to Action 301, register the timestamp, stamp_t2, of the call reestablishment message. The period of loss of coverage may be concluded as follows. For UE1, T_hole may be calculated as being equal to stamp_t2-stamp_t1, although this period may depend on the speed of UE1, v_UE1. For another UE, UE2, similarly, stamp_t2-stamp_t1 for UE2 in addition to v_UE2 may be collected. Then, based on the different stamp_t2-stamp_t1 and v_UE for different UEs, the network node 110 may, in addition to calculating T_hole also deduce the size of the radio coverage hole.

The second procedure for detecting the radio coverage hole may comprise detecting an inter RAT handover procedure in the wireless communications network 100. When an inter RAT handover procedure is triggered from a serving cell such as the first cell 121, running on a first RAT1, e.g., 5G, towards a target cell such as the second cell 122, running on a second RAT2, e.g. 4G, this may be understood to mean that most probably a UE, e.g., UE1, may be heading towards an area, e.g., area1, of RAT1 where UE1 may experience a radio coverage hole from RAT1. This assumption may be based on the fact that the purpose of the operator may be understood to be to make the radio coverage of any RAT, e.g. 5G, continuous, that is being present in all the geographical locations in the wireless communications network 100. Hence, another way for the network node 110 to detect a radio coverage hole in the wireless communications network 100 may be to detect the triggering of a handover procedure from one RAT to another RAT, e.g., in the example used above, when a handover procedure may be triggered from the first cell 121, e.g., 5G cell1 to the second cell 122, e.g., a 4G cell2. In such scenario, the network node 110 may, in accordance to Action 301, record the timestamp, stamp_t1, of the RRC measurement message sent by UE1 to the serving cell1 of RAT1 that may contain a handover event, e.g., event A2, that is, when the serving cell may become worse than an absolute threshold. The network node 110 may then, in accordance to Action 301, record the timestamp, stamp_t2, of the RRC message when the UE1 may connect to cell2 of RAT2 during the handover procedure. The network node 110 may also record, in accordance to Action 301, a third timestamp, stamp_t3, when the UE1 may want to return to cell1 of RAT1 after crossing area1. It may be noted that UE1 may return to RAT1 because in the example used herein, it may be understood to be considered that any cell of RAT1, in the example used herein, a 5G cell, may have a higher priority over any cell of RAT2, in the example used herein, a 4G, and, as a result, UE1 may return to cell1 once it may detect again, after crossing the degraded area, a radio signal from cell1. By combining the speed of UEs, e.g., v_UE, crossing area1 together with the three mentioned timestamps, e.g., stamp_t1, stamp_t2 and stamp_t3, the network node 110 may be able to estimate the size of area1, and also predict the period T_hole that may be experienced by any UE that may be heading towards area1.

It may be understood by the skilled person that any of the two procedures just described may also be used in combination with machine-learning methods. As a second example, Example 2, of embodiments that may use machine-learning to determine the predictive model of the time of duration, the determining in this Action 302 of the estimation may be performed by predicting the duration of experiencing loss of coverage by collecting timestamps of reported Reference Signal Received Power (RSRP).

In Example 1 above, in order to estimate the potential duration, T_hole, that a UE may experience by crossing an area, area1, of loss of coverage or of weak signal, timestamps of signalling messages, triggered during some particular existing signalling procedures, e.g., call reestablishment and inter RAT handover, together with UE velocity, were considered. In this Example 2, the UE values and timestamps of reported RSRP instances may be considered in the estimation of the duration, T_hole.

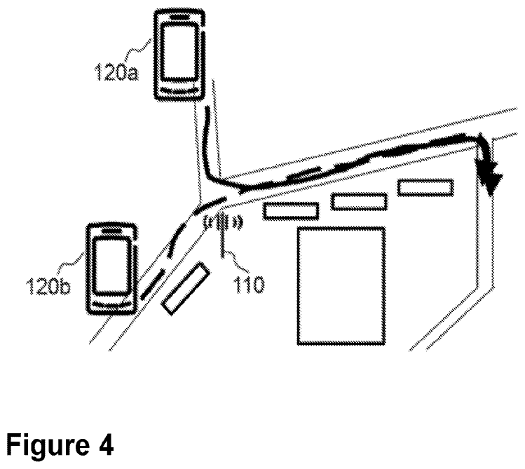

Based on received device data from measurement reports, obtained in accordance to Action 301, the network node 110 may learn, for example, what sequence of signal quality measurements, e.g., RSRP, that may result in a large signal quality drop, e.g., turning around the corners in the schematic representation of FIG. 4, for example, by dividing a periodic reported RSRP data into a training and prediction window. In this example, in FIG. 4, two devices 120a and 120b may be turning around the same corner according to the location plot, the first device 120a, may first turn around the corner and experience a coverage outage. Then, according to embodiments herein, the network node 110, or another node in the wireless communications network 100 may predict the drop for the second device 120b using learning from the experience of the first device 120a.

The learning may be performed by feeding RSRP in t1, . . . , tn into a machine learning model, e.g., neural network, and then, learn the RSRP in tn+1, tn+2. After the model may have been trained, it may be used to predict future coverage outages. It may thus provide an estimate of the T_hole for a UE such as the wireless device 130, by using learnings from previous UEs such as the one or more first wireless devices 131.

In order to build an ML model that may predict the duration of a coverage hole, it may require that the wireless communications network 100, e.g., the network node 110, may have to collect such data. In one example, the network node 110 may request a subset of the first wireless devices 131 with less demanding traffic, e.g., first wireless devices 131 with a large buffer of video data, to remain on the RAT for a longer duration after radio-link failure (RLF), to collect such training set data at the network node 110 according to Action 301. The request may be introduced via a new element in the standards, that may enable the network node 110 to gather such coverage hole duration, in case the first wireless devices 131 may have no high priority traffic. The request may be, for example, a request for a first wireless device 131 on how long it may have stay on the RAT after RLF, or at least how long one of its receiver chains may have stay on the RAT, since some first wireless devices 131 may support dual connectivity.

In another example, as explained in Action 301, the wireless device 130, or any of the one or more first devices 131, may estimate and report its own trajectory to the network node 110, which may be obtained by the network node 110 according to Action 301. Next, the network node 110 may perform the coverage outage prediction using such trajectory.

The advantages provided by the network node 110 performing the determining of the estimation in this Action 302 may be understood to be the same as those described for the Action 203, as performed by the wireless device 130.

### Action 303

In this Action 303, the network node 110 sends the one or more first indications to the wireless device 130 operating in the communications network 100. The one or more first indications indicate the determined estimation. For example, whatever the method may have been used in Action 302 to calculate value of T, e.g., of any of the three examples above, the result may then be considered as an input for this Action 303.

The one or more first indications may indicate one of: i) the predetermined static value, ii) the second information derived or obtained from the one or more first wireless devices 131 operating in the wireless communications network 100, iii) the estimation, iv) the assistance information enabling the wireless device 130 to derive the estimation of the time duration, and v) the location where the wireless device 130 may have to fetch the estimation or the assistance information. In such embodiments wherein the one or more first indications may indicate the location, the one or more first indications may lack the estimation or the assistance information.

The assistance information may comprise one of: a) the historical information comprising at least one of: i) the location information, ii) the device information, and iii) the mobility information, and b) the reconnection information to be used by the wireless device 130 when out of coverage.

In some embodiments, the one or more first indications may indicate at least one of: i) the presence of the outage of coverage, ii) the second location where the unplanned outage of coverage may be estimated to be experienced at, iii) the length of the unplanned outage, and iv) the confidence interval of the estimation, as determined by the network node 110.

The sending in this Action 303 of the one or more first indications may be via broadcasting or dedicated signalling.

The advantages provided by the network node 110 performing the sending of the one or more first indications in this Action 303 may be understood to be the same as those described for the Action 202, as performed by the wireless device 130.

As a summarized view of some of the foregoing, it may be understood that embodiments herein may provide the wireless device 130 with an alternative approach to that of the existing methods described earlier, wherein the time of duration of the unplanned outage of coverage may not be known. Because without the knowledge of T, such it may be the case when a UE may pass by a radio coverage hole, the UE may not be provided by the alternative approach provided herein. In fact, the UE may never know for how long, e.g., whether a few seconds or a few minutes, it may have to wait until the radio coverage of cell1 may be back. In other words, without knowing the value of T, the UE may be only left with the first option described above, which makes the UE systematically release its communication on the serving cell1, e.g., 5G and start a new communication on cell2, e.g., 4G.

In order to overcome the problems mentioned above, according to some embodiments herein, the network node 110 may send, based on notification coming from different first wireless devices 131 that may be experiencing, at one particular location X, e.g., an out-of-coverage event from the serving first cell 121, e.g., cell1, assistance information to the wireless device 130. This may be either the value of T that may correspond to the duration in which the wireless device 130 may experience the out-of-coverage at location X, or some assisted information that may allow the wireless device 130 to calculate the value T at location X.

As a consequence, the wireless device 130 may then decide whether to start connecting to the second cell 122, e.g., a neighboring cell2, or wait to connect again to the serving first cell 121, e.g., cell1, based on the received value T and on some other UE conditions, e.g., if RAT2 of the second cell 122 is different than RAT1 of the first cell 121.

According to other embodiments herein, after the wireless device 130, equipped with AI and ML, may lose its radio coverage from the serving first cell 121, e.g., cell1 of RAT1, the decision to initiate immediately a connection to the second cell 122, e.g., another cell2 of RAT2, as in existing methods, or to wait for a period of time in order to reestablish the call on the serving first cell 121, e.g., cell1, may be taken by the wireless device 130 after estimating the value of T by itself, without any assistance from the network node 110, and it may be based on the different information. Following are only two examples; other examples have already been described earlier.

In one example, the decision on whether or not to initiate a new connection setup to the second cell 122 after experiencing the outage of coverage at the first cell 121 may be based on the expected duration T during which the wireless device 130 may stay without radio coverage from the serving first cell 121, where the value of T may be calculated by the new functionality implemented on the wireless device 130.

In another example, the decision on whether or not to initiate a new connection setup to the second cell 122 after experiencing the outage of coverage at the first cell 121 may be based on the value of parameters on the serving and neighboring cells, e.g., the value of RAT and the location, e.g. TAC, may be on the serving first cell 121, e.g., cell1, and on the second cell 122, e.g., neighboring cell2.

According to further embodiments herein, the wireless device 130 the equipped by a static timer T that may be, in some embodiments, hardcoded at the wireless device 130 and the value may be given by vendor of the wireless device 130 or by a default value that may be incorporated in a future release of an existing standard, in particular in 3GPP 38.331, v. 16.10.0 RRC protocol. In other embodiments, the static timer T may be given to the wireless device 130 by the network node 110, e.g. via broadcast or dedicated signaling over the air interface, based on a value selected by the operator and which may change from one cell to another cell.

Thanks to the availability of the value of T, the wireless device 130 may then take best decision on whether a) to move immediately to the second cell 122, e.g., another cell2 of RAT2, and trigger a new call there, as in existing methods, or b) remain camping on the second cell 122, e.g., cell2, without triggering any signaling procedure in the second cell 122, e.g., cell2, but rather wait for a period of time in order to reestablish the call on the first cell 121, e.g., the serving cell1.

It may be understood that whenever the estimation of the time of duration of the unplanned outage of coverage may not be the static value of the duration of time, as well as in all existing methods that may be based on AI and ML, the network and/or the wireless device 130 may estimate the value of T in our example, as well as other values in other examples, only after one or more UEs, the first wireless devices 131, may have already experienced the degradation at location X. Whereas when, according to embodiments herein, the estimation of the time of duration of the unplanned outage of coverage may be the static value of the duration of time, as the wireless device 130 may already be equipped with the value of T, e.g., a hardcoded value, then, even though the wireless device 130 may be passing for the first time by location X, the wireless device 130 may take the best decision on whether to connect immediately on the second cell 122, e.g., cell2 or wait, for a period T, on the second cell 122, without triggering any signalling procedure, and then reconnect to the first cell 121, e.g., cell1.

Certain embodiments disclosed herein may provide one or more of the following technical advantage(s), which may be summarized as follows. Embodiments herein may enable, when the wireless device 130 may lose its radio coverage from the first cell 121 of a first low latency RAT, e.g. 5G cell1, to assist the wireless device 130 in taking the best decision on whether to a) perform a new connection setup on the second cell 122 of, e.g., a second higher latency RAT, e.g. 4G cell2, or b) wait for a period of time in order to reestablish the connection on the first cell 121 of the first RAT. This may be understood to bring many advantages.

A first advantage of embodiments herein may be for the communication. Embodiments herein may be understood to prevent the wireless device 130 from performing immediately a connection on the second cell 122 of the second RAT whenever there may be a chance for a quick return to first cell 121 of first RAT. This may in turn bring two further advantages.

A first further advantage of embodiments herein on the communication may be that the running connection on the first cell 121 5G cell1 may not be dropped. This may be understood to be particularly relevant whenever the subscriber may be experiencing an emergency situation, for example, if the subscriber has dialled emergency call 911 on the first cell 121, e.g., 5G cell1. In another example, the subscriber may be involved in a remote health operation and while downloading a video, the wireless device 130 may lose the radio coverage from the serving first cell 121, e.g., 5G cell1, while being at the end of the download, e.g. at 80% of the download.

According to existing methods, in the first example, the emergency call is dropped, and the subscriber has to initiate a long connection setup from scratch on the second cell 122, e.g., 4G cell2. In the second example, the download video is released at 80% and the UE has to initiate a new connection setup o the second cell 122, e.g., 4G cell2, where the UE has to download the previously dropped video from scratch. As a result, in both examples, the drop of the communication will have a bad impact on the subscriber. In contrast, according to embodiments herein, in the first example, the emergency call may not be dropped, and in the second example, the download may be resumed at 80% on the initial low latency serving RAT.

A second further advantage of embodiments herein on the communication may be that the period of the degradation of the connection may be less whenever the wireless device 130 may wait and reestablish its call on the first cell 121 of first RAT, in comparison to existing methods, where the UE moves to the second cell of the second RAT. This may be understood to stem from the fact that the duration of a connection reestablishment procedure may always be shorter than the duration of a new connection setup.

A second advantage of embodiments herein may be that they may provide an approach for wireless devices that may encounter a degradation for the first time. Existing AI and ML procedures do not work on a UE that encounters a degradation for the first time. Because by nature, they need some input to build their results on it. In contrast, some embodiments herein, wherein the wireless device 130 may use the estimation as the predetermined static value of the duration of time, may allow the wireless device 130 from its first experiences of a radio loss from the serving first cell 121, e.g., cell1, to take the best decision on whether to move immediately on the second cell 122, e.g., cell2, or to wait for a period T to reconnect to the first cell 121, e.g., cell1.

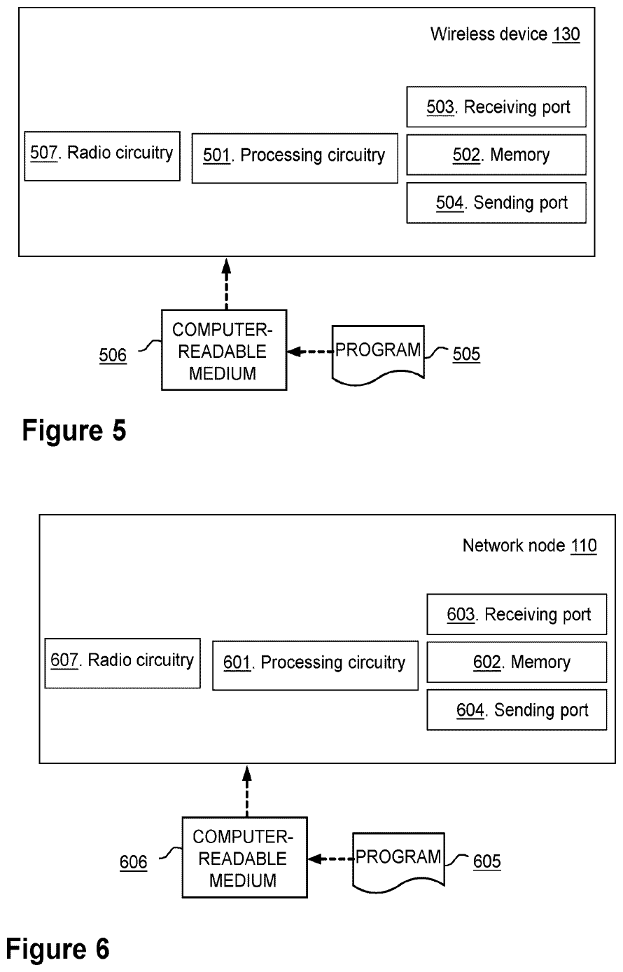

FIG. 5 depicts an example of the arrangement that the wireless device 130 may comprise to perform the method described in FIG. 2. The wireless device 130 may be understood to be for handling the future outage of coverage. The wireless device 130 is configured to operate in the wireless communications network 100.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the wireless device 130, and will thus not be repeated here. For example, the outage of coverage may be understood herein as a loss of radio coverage.

The wireless device 130 is configured to, e.g. by means of a determining unit within the wireless device 130 configured to, determine, wherein the future outage of coverage is unplanned and the duration of time of the future outage of coverage is unknown, the estimation of the time of duration of the outage of coverage.

The wireless device 130 is also configured to, e.g. by means of the determining unit configured to, determine, after experiencing the outage of coverage at the first cell 121, whether or not to initiate the new connection setup to the second cell 122, based on the estimation configured to be determined.

In some embodiments, the determining of the estimation may be configured to be based on one of: a) the first information configured to be collected by the wireless device 130 after the previous occurrence of the outage of coverage, b) the predetermined static value of the duration of time, pre-configured at the wireless device 130, c) the one or more first indications configured to be received from the network node 110 configured to operate in the wireless communications network 100. The one or more first indications may be configured to indicate one of: i) the predetermined static value, ii) the second information configured to be derived or obtained from the one or more first wireless devices 131 configured to operate in the wireless communications network 100, iii) the estimation, iv) the assistance information configured to enable the wireless device 130 to derive the estimation of the time duration, and v) the location where the wireless device 130 may have to fetch the estimation or the assistance information. In such embodiments, the one or more first indications may be configured to lack the estimation or the assistance information.

The wireless device 130 may be further configured to, e.g. by means of a collecting unit within the wireless device 130 configured to, collect the first information. The first information may be configured to be: i) the first location of the previous occurrence of the outage of coverage, ii) the first time of occurrence of the loss of radio coverage with the first cell 121 at the previous occurrence of the outage of coverage, iii) the second time of occurrence of the triggering of the connection setup to the second cell 122 during the outage, iv) the third time of occurrence of regain of radio coverage with the first cell 121, and v) the velocity of the wireless device 130 during the previous occurrence of the outage of coverage.

In some embodiments, the assistance information may be configured to comprise one of: a) the historical information configured to comprise at least one of: i) the location information, ii) the device information, and iii) the mobility information, and b) the reconnection information to be used by the wireless device 130 when out of coverage.

In some embodiments, the pre-determined value may be configured to be based on at least one of: i) the category of the wireless device 130, and ii) the one or more properties of the power supply of the device 130.

In some embodiments, the wireless device 130 may be further configured to, e.g. by means of a receiving unit within the wireless device 130 configured to, receive the one or more first indications from the network node 110 via broadcasting or dedicated signalling.

In some embodiments, the wireless device 130 may be further configured to, e.g. by means of a storing unit within the wireless device 130 configured to, store the estimation configured to be determined in the memory of the wireless device 130. The determining of whether or not to initiate the new connection setup to the second cell 122 may be configured to be based on the estimation configured to be determined and stored.

In some embodiments, the one or more first indications may be configured to indicate at least one of: i) the presence of the outage of coverage, ii) the second location where the unplanned outage of coverage may be configured to be estimated to be experienced at, iii) the length of the unplanned outage, and) the confidence interval of the estimation, as configured to be determined by the network node 110.

In some embodiments, at least one of the following may apply: i) the first cell 121 may be configured to operate on a different RAT, than the second cell 122, ii) the determining of the estimation may be configured to be performed by one of: a) statistical methods, and b) using machine-learning to determine the predictive model of the time of duration, ii) the determining of whether or not to initiate the connection call setup to the second cell 122 may be configured to comprise one of: a) refraining from initiating the new connection setup to the second cell 122, and b) initiating the new connection setup to the second cell 122, and iv) the determining of whether or not to initiate the new connection setup to the second cell 122 may be further configured to be based on at least one of: a) the one or more respective parameters of the first cell 121 and the second cell 122, b) the second indication configured to indicate the time period the wireless device 130 may have to select a cell after the outage, before it may have to go into idle mode, c) the respective duration of time for initiating the new connection setup in a respective radio access technology, d) the energy consumption considerations, e) the service requirements of the wireless device 130, f) the traffic predictions, and g) the assistance information configured to be obtained from the wireless communications network 100.

The embodiments herein in the wireless device 130 may be implemented through one or more processors, such as a processing circuitry 501 in the wireless device 130 depicted in FIG. 5, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the wireless device 130. One such carrier may be in the form of a CD ROM disc. It is however feasible with other data carriers such as a memory stick. The computer program code may furthermore be provided as pure program code on a server and downloaded to the wireless device 130.

The wireless device 130 may further comprise a memory 502 comprising one or more memory units. The memory 502 is arranged to be used to store obtained information, store data, configurations, schedulings, and applications etc. to perform the methods herein when being executed in the wireless device 130.

In some embodiments, the wireless device 130 may receive information from, e.g., the network node 110, the second network node 112, any of the other one or more first wireless devices 131 and/or another structure in the wireless communications network 100, through a receiving port 503. In some embodiments, the receiving port 503 may be, for example, connected to one or more antennas in wireless device 130. In other embodiments, the wireless device 130 may receive information from another structure in the wireless communications network 100 through the receiving port 503. Since the receiving port 503 may be in communication with the processing circuitry 501, the receiving port 503 may then send the received information to the processing circuitry 501. The receiving port 503 may also be configured to receive other information.

The processing circuitry 501 in the wireless device 130 may be further configured to transmit or send information to e.g., the network node 110, the second network node 112, any of the other one or more first wireless devices 131 and/or another structure in the wireless communications network 100, through a sending port 504, which may be in communication with the processing circuitry 501, and the memory 502.

Those skilled in the art will also appreciate that the units comprised within the wireless device 130 described above as being configured to perform different actions, may refer to a combination of analog and digital circuits, and/or one or more processors configured with software and/or firmware, e.g., stored in memory, that, when executed by the one or more processors such as the processing circuitry 501, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units comprised within the wireless device 130 described above as being configured to perform different actions described above may be implemented as one or more applications running on one or more processors such as the processing circuitry 501.

Thus, the methods according to the embodiments described herein for the wireless device 130 may be respectively implemented by means of a computer program 505 product, comprising instructions, i.e., software code portions, which, when executed on at least one processing circuitry 501, cause the at least one processing circuitry 501 to carry out the actions described herein, as performed by the wireless device 130. The computer program 505 product may be stored on a computer-readable storage medium 506. The computer-readable storage medium 506, having stored thereon the computer program 505, may comprise instructions which, when executed on at least one processing circuitry 501, cause the at least one processing circuitry 501 to carry out the actions described herein, as performed by the wireless device 130. In some embodiments, the computer-readable storage medium 506 may be a non-transitory computer-readable storage medium, such as a CD ROM disc, or a memory stick. In other embodiments, the computer program 505 product may be stored on a carrier containing the computer program 505 just described, wherein the carrier is one of an electronic signal, optical signal, radio signal, or the computer-readable storage medium 506, as described above.

The wireless device 130 may comprise a communication interface configured to facilitate, or an interface unit to facilitate, communications between the wireless device 130 and other nodes or devices, e.g., the network node 110, the second network node 112, any of the other one or more first wireless devices 131 and/or another structure in the wireless communications network 100. The interface may, for example, include a transceiver configured to transmit and receive radio signals over an air interface in accordance with a suitable standard.

In other embodiments, the wireless device 130 may comprise a radio circuitry 507, which may comprise e.g., the receiving port 503 and the sending port 504.

The radio circuitry 507 may be configured to set up and maintain at least a wireless connection with any of the network node 110, the second network node 112, any of the other one or more first wireless devices 131 and/or another structure in the wireless communications network 100. Circuitry may be understood herein as a hardware component.

Hence, embodiments herein also relate to the wireless device 130 operative to operate in the wireless communications network 100. The wireless device 130 may comprise the processing circuitry 501 and the memory 502, said memory 502 containing instructions executable by said processing circuitry 501, whereby the wireless device 130 is further operative to perform the actions described herein in relation to the wireless device 130, e.g., in FIG. 2.

FIG. 6 depicts an example of the arrangement that the network node 110 may comprise to perform the method described in FIG. 3. The network node 110 may be understood to be for handling the future outage of coverage. The network node 110 is configured to operate in the wireless communications network 100.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the network node 110, and will thus not be repeated here. For example, the outage of coverage may be understood herein as a loss of radio coverage.

The network node 110 is configured to, e.g. by means of a determining unit within the network node 110 configured to, determine, wherein the future outage of coverage is unplanned and the duration of time of the future outage of coverage is unknown, the estimation of the time of duration of the outage of coverage.

The network node 110 may also configured to, e.g. by means of a sending unit configured to, send the one or more first indications to the wireless device 130 configured to operate in the communications network 100. The one or more first indications are configured to indicate the estimation configured to be determined.

In some embodiments, the estimation configured to be determined may be configured to be one of: a) the predetermined static value of the duration of time, and b) derived or obtained from the one or more first wireless devices 131 configured to operate in the wireless communications network 100.

In some embodiments, the pre-determined value may be configured to be based on at least one of: i) the category of the wireless device 130, and ii) the one or more properties of the power supply of the device 130.

The one or more first indications may be configured to indicate one of: i) the predetermined static value, ii) the second information configured to be derived or obtained from the one or more first wireless devices 131 configured to operate in the wireless communications network 100, iii) the estimation, iv) the assistance information configured to enable the wireless device 130 to derive the estimation of the time duration, and v) the location where the wireless device 130 may have to fetch the estimation or the assistance information. In such embodiments, the one or more first indications may be configured to lack the estimation or the assistance information.

In some embodiments, the assistance information may be configured to comprise one of: a) the historical information configured to comprise at least one of: i) the location information, ii) the device information, and iii) the mobility information, and b) the reconnection information to be used by the wireless device 130 when out of coverage.

In some embodiments, the second information may be configured to comprise at least one of: i) the first timestamps of signalling messages configured to be received from the one or more first wireless devices 131, ii) the second timestamps of measurement reports configured to be received from the one or more first wireless devices 131, and iii) the respective velocity of the one or more first devices 131.

The network node 110 may be further configured to, e.g. by means of an obtaining unit within the network node 110 configured to, obtain the second information.

In some embodiments, the determining of the estimation may be configured to be performed, using the second information, by one of: i) statistical calculations lacking usage of machine-learning methods, and ii) using machine-learning to determine the predictive model of the time of duration.

In some embodiments, the one or more first indications may be configured to indicate at least one of: i) the presence of the outage of coverage, ii) the second location where the unplanned outage of coverage may be configured to be estimated to be experienced at, iii) the length of the unplanned outage, and) the confidence interval of the estimation, as configured to be determined by the network node 110.

In some embodiments, the sending of the one or more first indications may be configured to be via broadcasting or the dedicated signalling.

The embodiments herein in the network node 110 may be implemented through one or more processors, such as a processing circuitry 601 in the network node 110 depicted in FIG. 6, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the network node 110. One such carrier may be in the form of a CD ROM disc. It is however feasible with other data carriers such as a memory stick. The computer program code may furthermore be provided as pure program code on a server and downloaded to the network node 110.

The network node 110 may further comprise a memory 602 comprising one or more memory units. The memory 602 is arranged to be used to store obtained information, store data, configurations, schedulings, and applications etc. to perform the methods herein when being executed in the network node 110.

In some embodiments, the network node 110 may receive information from, e.g., the wireless device 130, the second network node 112, any of the one or more first wireless devices 131 and/or another structure in the wireless communications network 100, through a receiving port 603. In some embodiments, the receiving port 603 may be, for example, connected to one or more antennas in network node 110. In other embodiments, the network node 110 may receive information from another structure in the wireless communications network 100 through the receiving port 603. Since the receiving port 603 may be in communication with the processing circuitry 601, the receiving port 603 may then send the received information to the processing circuitry 601. The receiving port 603 may also be configured to receive other information.

The processing circuitry 601 in the network node 110 may be further configured to transmit or send information to e.g., the wireless device 130, the second network node 112, any of the one or more first wireless devices 131 and/or another structure in the wireless communications network 100, through a sending port 604, which may be in communication with the processing circuitry 601, and the memory 602.

Those skilled in the art will also appreciate that the units comprised within the network node 110 described above as being configured to perform different actions, may refer to a combination of analog and digital circuits, and/or one or more processors configured with software and/or firmware, e.g., stored in memory, that, when executed by the one or more processors such as the processing circuitry 601, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units comprised within the network node 110 described above as being configured to perform different actions described above may be implemented as one or more applications running on one or more processors such as the processing circuitry 601.

Thus, the methods according to the embodiments described herein for the network node 110 may be respectively implemented by means of a computer program 605 product, comprising instructions, i.e., software code portions, which, when executed on at least one processing circuitry 601, cause the at least one processing circuitry 601 to carry out the actions described herein, as performed by the network node 110. The computer program 605 product may be stored on a computer-readable storage medium 606. The computer-readable storage medium 606, having stored thereon the computer program 605, may comprise instructions which, when executed on at least one processing circuitry 601, cause the at least one processing circuitry 601 to carry out the actions described herein, as performed by the network node 110. In some embodiments, the computer-readable storage medium 606 may be a non-transitory computer-readable storage medium, such as a CD ROM disc, or a memory stick. In other embodiments, the computer program 605 product may be stored on a carrier containing the computer program 605 just described, wherein the carrier is one of an electronic signal, optical signal, radio signal, or the computer-readable storage medium 606, as described above.

The network node 110 may comprise a communication interface configured to facilitate, or an interface unit to facilitate, communications between the network node 110 and other nodes or devices, e.g., the wireless device 130, the second network node 112, any of the one or more first wireless devices 131 and/or another structure in the wireless communications network 100. The interface may, for example, include a transceiver configured to transmit and receive radio signals over an air interface in accordance with a suitable standard.

In other embodiments, the network node 110 may comprise a radio circuitry 607, which may comprise e.g., the receiving port 603 and the sending port 604.

The radio circuitry 607 may be configured to set up and maintain at least a wireless connection with any of the wireless device 130, the second network node 112, any of the one or more first wireless devices 131 and/or another structure in the wireless communications network 100. Circuitry may be understood herein as a hardware component.

Hence, embodiments herein also relate to the network node 110 operative to operate in the wireless communications network 100. The network node 110 may comprise the processing circuitry 601 and the memory 602, said memory 602 containing instructions executable by said processing circuitry 601, whereby the network node 110 is further operative to perform the actions described herein in relation to the network node 110, e.g., in FIG. 3.

When using the word “comprise” or “comprising”, it shall be interpreted as non-limiting, i.e., meaning “consist at least of”.

The embodiments herein are not limited to the above-described preferred embodiments. Various alternatives, modifications and equivalents may be used. Therefore, the above embodiments should not be taken as limiting the scope of the invention.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

Any of the terms processor and circuitry may be understood herein as a hardware component.

As used herein, the expression “in some embodiments” has been used to indicate that the features of the embodiment described may be combined with any other embodiment or example disclosed herein.

As used herein, the expression “in some examples” has been used to indicate that the features of the example described may be combined with any other embodiment or example disclosed herein.

1-34. (canceled)

35. A method performed by a wireless device for handling a future outage of coverage, the wireless device operating in a wireless communications network, the method comprising:
determining, wherein the future outage of coverage is unplanned and a duration of time of the future outage of coverage is unknown, an estimation of the time of duration of the outage of coverage; and
determining, after experiencing the outage of coverage at a first cell, whether or not to initiate a new connection setup to a second cell, based on the determined estimation.

36. The method of claim 35, wherein the determining the estimation is based on one of:
first information collected by the wireless device after a previous occurrence of the outage of coverage;
a predetermined static value of the duration of time, pre-configured at the wireless device;
one or more first indications received from a network node operating in the wireless communications network, wherein the one or more first indications indicate one of:
the predetermined static value;
second information derived or obtained from one or more first wireless devices operating in the wireless communications network;
the estimation;
assistance information enabling the wireless device to derive the estimation of the time duration;
a location where the wireless device is to fetch the estimation or the assistance information, and wherein the one or more first indications lack the estimation or the assistance information.

37. The method of claim 36, further comprising collecting the first information, the first information comprising:
a first location of the previous occurrence of the outage of coverage;
a first time of occurrence of a loss of radio coverage with the first cell at the previous occurrence of the outage of coverage;
a second time of occurrence of a triggering of a connection setup to the second cell during the outage;
a third time of occurrence of regain of radio coverage with the first cell; and
a velocity of the wireless device during the previous occurrence of the outage of coverage.

38. The method of claim 36, wherein the assistance information comprises one of:
historical information comprising at least one of:
location information;
device information; and
mobility information; and
reconnection information to be used by the wireless device when out of coverage.

39. The method of claim 36, wherein the predetermined static value is based on at least one of:
a category of the wireless device; and
one or more properties of a power supply of the wireless device.

40. The method of claim 36, further comprising at least one of:
receiving the one or more first indications from the network node via broadcasting or dedicated signaling; and
storing the determined estimation in a memory of the wireless device, and wherein the determining of whether or not to initiate the new connection setup to the second cell is based on the stored determined estimation.

41. The method of claim 36, wherein the one or more first indications indicate at least one of:
a presence of the outage of coverage;
a second location where the unplanned outage of coverage is estimated to be experienced;
a length of the unplanned outage; and
a confidence interval of the estimation, as determined by the network node.

42. A method performed by a network node for handling a future outage of coverage, the network node operating in a wireless communications network, the method comprising:
determining, wherein the future outage of coverage is unplanned and a duration of time of the future outage of coverage is unknown, an estimation of the time of duration of the outage of coverage; and
sending one or more first indications to a wireless device operating in the communications network, the one or more first indications indicating the determined estimation.

43. The method of claim 42, wherein the determined estimation is one of:
a predetermined static value of the duration of time; and
derived or obtained from one or more first wireless devices operating in the wireless communications network.

44. The method of claim 43, wherein the predetermined value is based on at least one of:
a category of the wireless device; and
one or more properties of a power supply of the device.

45. The method of claim 43, wherein the one or more first indications indicate one of:
the predetermined static value;
second information derived or obtained from one or more first wireless devices operating in the wireless communications network;
the estimation;
assistance information enabling the wireless device to derive the estimation of the time duration; and
a location where the wireless device is to fetch the estimation or the assistance information, and wherein the one or more first indications lack the estimation or the assistance information.

46. The method of claim 45, wherein the assistance information comprises one of:
historical information comprising at least one of:
location information;
device information; and
mobility information; and
reconnection information to be used by the wireless device when out of coverage.

47. The method of claim 45, the second information comprises at least one of:
first timestamps of signaling messages received from the one or more first wireless devices;
second timestamps of measurement reports received from the one or more first wireless devices; and
a respective velocity of the one or more first devices.

48. The method of claim 45, further comprising:
obtaining the second information, and
wherein the determining of the estimation is performed, using the second information, by one of:
statistical calculations lacking usage of machine-learning methods, and
using machine-learning to determine a predictive model of the time of duration.

49. The method of claim 42, wherein the one or more first indications indicate at least one of:
a presence of the outage of coverage;
a second location where the unplanned outage of coverage is estimated to be experienced at;
a length of the unplanned outage; and
a confidence interval of the estimation, as determined by the network node.

50. The method of claim 42, wherein the sending of the one or more first indications is via broadcasting or dedicated signaling.

51. A wireless device for handling a future outage of coverage, the wireless device being configured to operate in a wireless communications network, the wireless node comprising:
processing circuitry; and
a memory containing instruction executable by the processing circuitry whereby the wireless device is further configured to:
determine, wherein the future outage of coverage is unplanned and a duration of time of the future outage of coverage is unknown, an estimation of the time of duration of the outage of coverage; and
determine, after experiencing the outage of coverage at a first cell, whether or not to initiate a new connection setup to a second cell, based on the estimation configured to be determined.

52. The wireless device of claim 51, wherein the determining of the estimation is configured to be based on one of:
first information configured to be collected by the wireless device after a previous occurrence of the outage of coverage;
a predetermined static value of the duration of time, pre-configured at the wireless device;
one or more first indications configured to be received from a network node configured to operate in the wireless communications network, wherein the one or more first indications are configured to indicate one of:
the predetermined static value;
second information configured to be derived or obtained from one or more first wireless devices configured to operate in the wireless communications network;
the estimation;
assistance information configured to enable the wireless device to derive the estimation of the time duration; and
a location where the wireless device is to fetch the estimation or the assistance information, and wherein the one or more first indications are configured to lack the estimation or the assistance information.

53. The wireless device of claim 52, being further configured to collect the first information, the first information being configured to be:
a first location of the previous occurrence of the outage of coverage;
a first time of occurrence of a loss of radio coverage with the first cell at the previous occurrence of the outage of coverage;
a second time of occurrence of a triggering of a connection setup to the second cell during the outage;
a third time of occurrence of regain of radio coverage with the first cell; and
a velocity of the wireless device during the previous occurrence of the outage of coverage.

54. A network node, for handling a future outage of coverage, the network node being configured to operate in a wireless communications network, the network node comprising:
processing circuitry;
a memory containing instructions executable by the processing circuitry whereby the network node is further configured to:
determine, wherein the future outage of coverage is unplanned and a duration of time of the future outage of coverage is unknown, an estimation of the time of duration of the outage of coverage; and
sending one or more first indications to a wireless device configured to operate in the communications network, the one or more first indications being configured to indicate the estimation configured to be determined.

55. The network node of claim 54, wherein the determined estimation is one of:
a predetermined static value of the duration of time; and
derived or obtained from one or more first wireless devices operating in the wireless communications network.
